(19) United States
(12) Patent Application Publication
(10) Pub. No.: US 2023/0305543 A1
(43) Pub. Date: Sep. 28, 2023

(54) ENHANCING AUTONOMOUS OPERATION IN ROBOTIC DEVICES WITH HUMAN INTERVENTION

(71) Applicant: GERALD BRANTNER, PALO ALTO, CA (US)

(72) Inventor: GERALD BRANTNER, PALO ALTO, CA (US)

(21) Appl. No.: 18/326,755

(22) Filed: May 31, 2023

Related U.S. Application Data
(63) Continuation-in-part of application No. 18/070,157, filed on Nov. 28, 2022.
Application No. 18/070,157 is a continuation of application No. 17/087,921, filed on Nov. 3, 2020, now Pat. No. 11,513,505.
Application No. 17/087,921 is a continuation of application No. 17/080,601, filed on Oct. 26, 2020, now abandoned.
(60) Provisional application No. 63/050,004, filed on Jul. 9, 2020.

(51) Int. Cl. G05B 19/418; H04L 47/78; H04L 67/025; G08B 21/00; B25J 9/16; G01N 19/08; G06Q 10/0631; G01L 5/22; G06Q 10/20; G06Q 10/0639

(52) U.S. Cl. CPC G05B 19/41875; H04L 47/788; H04L 67/025; G08B 21/00; B25J 9/163; G05B 19/4185; B25J 9/1687; G01N 19/08; B25J 9/1661; G06Q 10/06311; G01L 5/226; G06Q 10/20; G06Q 10/06395

(57) ABSTRACT

Methods, apparatuses, systems, and computer program products for enhancing autonomous operation in robotic devices with human intervention are disclosed. In a particular embodiment, a method of enhancing autonomous operation in robotic devices with human intervention includes identifying, by an autonomous robotic device, that a state of an autonomous operation requires human intervention; transmitting, by the autonomous robotic device to a service controller, a service request based on the state; receiving, by the autonomous robotic device, a service response from the service controller, wherein the service response is generated by the service controller based on a plurality of interventionist responses from a plurality of human interventionists; and performing, by the autonomous robotic device, the autonomous operation in accordance with the service response.

### CROSS-REFERENCE TO RELATED APPLICATIONS

This application is a continuation in part of and claims priority from U.S. patent application Ser. No. 18/070,157, filed Nov. 28, 2022, which is a continuation application of and claims priority from U.S. patent application Ser. No. 17/087,921, filed Nov. 3, 2020, now U.S. Pat. No. 11,513,505, which is a continuation application of and claims priority from U.S. patent application Ser. No. 17/080,601, filed Oct. 26, 2020, which is a non-provisional application for patent entitled to a filing date and claiming the benefit of earlier-filed U.S. Provisional Patent Application Ser. No. 63/050,004, filed Jul. 9, 2020.

### BACKGROUND

An autonomous device is a device that performs some behaviors or tasks in an autonomous manner, without requiring human control or direction. In some instances, while performing an operation in an autonomous manner, the autonomous device may determine that the internal instructions/routines/processes of the autonomous device are incapable of successfully a) executing a given task, b) identifying a next task to perform, or c) judging whether a task was successfully completed, related to both a) and b), and c) either entirely, or with a required degree of certainty or confidence.

### SUMMARY

Methods, apparatuses, systems, and computer program products for enhancing autonomous operation in robotic devices with human intervention are disclosed. In a particular embodiment, a method of enhancing autonomous operation in robotic devices with human intervention includes a service controller selecting from a first plurality of human interventionists a first set of human interventionists to respond to a request associated with an autonomous device; transmitting the request to a first set of interventionist devices, each interventionist device of the first set of interventionist devices associated with a particular human interventionist in the first set of human interventionists; and receiving from the first set of interventionist devices, a first set of interventionist responses to the request.

In a particular embodiment, an apparatus for enhancing autonomous operation in robotic devices with human intervention includes a computer processor coupled to memory. In this embodiment, the memory includes computer program instructions that when executed by the computer processor cause the apparatus to carry out the operations of for each human interventionist of a plurality of human interventionists: transmitting, by a service controller, a test request to a particular interventionist device associated with a particular human interventionist; receiving from the particular interventionist device, by the service controller, a test response to the transmitted test request; and based on the test response, generating, by the service controller, a performance metric of the human interventionist; and based on the performance metrics of the human interventionists of the plurality of human interventionists, determining, by the service controller, a rating for each human interventionist of the plurality of human interventionists.

In a particular embodiment, a method for enhancing autonomous operation in robotic devices with human intervention includes the autonomous device placing an object in a stack of one or more objects; in response to placing the object in the stack, detecting instability in the stack; determining that correcting the instability requires a level of capability beyond a threshold associated with the autonomous device; and in response to determining that correcting the instability requires the level of capability beyond the threshold associated with the autonomous device, generating a request for human intervention.

In a particular embodiment, a method for enhancing autonomous operation in robotic devices with human intervention includes an autonomous device grasping an object with one or more components of the autonomous device; based on sensor input, determining a level of confidence that the object is securely grasped with the one or more components of the autonomous device; determining that the level does not satisfy a confidence requirement; and in response to determining that the level does not satisfy the confidence requirement, generating a request for human intervention.

In a particular embodiment, a method for enhancing autonomous operation in robotic devices with human intervention includes a service controller receiving a request from an autonomous device; generating a service response to the request. In this embodiment, the service response generated based on least one of: a first set of interventionist responses received from a first set of interventionist devices associated with a first set of human interventionists; and a first set of autonomous responses generated by an autonomous module. The method also includes training, by the service controller, the autonomous module using at least one of the first set of interventionist responses and the first set of autonomous responses.

### BRIEF DESCRIPTION OF THE DRAWINGS

FIG. 1 sets forth a diagram of a system configured for enhancing autonomous operation in robotic devices with human intervention according to embodiments of the present disclosure;

FIG. 2 sets forth a flowchart of an example method for enhancing autonomous operation in robotic devices with human intervention according to embodiments of the present disclosure;

FIG. 3 sets forth a flowchart of another example method for enhancing autonomous operation in robotic devices with human intervention according to embodiments of the present disclosure;

FIG. 4 sets forth a flowchart of another example method for enhancing autonomous operation in robotic devices with human intervention according to embodiments of the present disclosure;

FIG. 5A sets forth a flowchart of another example method for enhancing autonomous operation in robotic devices with human intervention according to embodiments of the present disclosure;

FIG. 5B sets forth a flowchart of another example method for enhancing autonomous operation in robotic devices with human intervention according to embodiments of the present disclosure;

FIG. 6 sets forth a flowchart of another example method for enhancing autonomous operation in robotic devices with human intervention according to embodiments of the present disclosure;

FIG. 7A sets forth a flowchart of another example method for enhancing autonomous operation in robotic devices with human intervention according to embodiments of the present disclosure;

FIG. 7B sets forth a flowchart of another example method for enhancing autonomous operation in robotic devices with human intervention according to embodiments of the present disclosure;

FIG. 8 sets forth a flowchart of another example method for enhancing autonomous operation in robotic devices with human intervention according to embodiments of the present disclosure;

FIG. 9 sets forth a flowchart of another example method for enhancing autonomous operation in robotic devices with human intervention according to embodiments of the present disclosure;

FIG. 10 sets forth a flowchart of another example method for enhancing autonomous operation in robotic devices with human intervention according to embodiments of the present disclosure;

FIG. 11 sets forth a flowchart of another example method for enhancing autonomous operation in robotic devices with human intervention according to embodiments of the present disclosure;

FIG. 12 sets forth a flowchart of another example method for enhancing autonomous operation in robotic devices with human intervention according to embodiments of the present disclosure;

FIG. 13 sets forth a flowchart of another example method for enhancing autonomous operation in robotic devices with human intervention according to embodiments of the present disclosure;

FIG. 14 sets forth a flowchart of another example method for enhancing autonomous operation in robotic devices with human intervention according to embodiments of the present disclosure;

FIG. 15 sets forth a flowchart of another example method for enhancing autonomous operation in robotic devices with human intervention according to embodiments of the present disclosure;

FIG. 16 sets forth a flowchart of another example method for enhancing autonomous operation in robotic devices with human intervention according to embodiments of the present disclosure;

FIG. 17 sets forth a flowchart of another example method for enhancing autonomous operation in robotic devices with human intervention according to embodiments of the present disclosure;

FIG. 18 sets forth a flowchart of another example method for enhancing autonomous operation in robotic devices with human intervention according to embodiments of the present disclosure;

FIG. 19A sets forth a flowchart of another example method for enhancing autonomous operation in robotic devices with human intervention according to embodiments of the present disclosure;

FIG. 19B sets forth a flowchart of another example method for enhancing autonomous operation in robotic devices with human intervention according to embodiments of the present disclosure;

FIG. 20 sets forth a flowchart of another example method for enhancing autonomous operation in robotic devices with human intervention according to embodiments of the present disclosure;

FIG. 21 sets forth a flowchart of another example method for enhancing autonomous operation in robotic devices with human intervention according to embodiments of the present disclosure;

FIG. 22 sets forth a flowchart of another example method for enhancing autonomous operation in robotic devices with human intervention according to embodiments of the present disclosure;

FIG. 23 sets forth a flowchart of another example method for enhancing autonomous operation in robotic devices with human intervention according to embodiments of the present disclosure;

FIG. 24 sets forth a flowchart of another example method for enhancing autonomous operation in robotic devices with human intervention according to embodiments of the present disclosure;

FIG. 25 sets forth a flowchart of another example method for enhancing autonomous operation in robotic devices with human intervention according to embodiments of the present disclosure;

FIG. 26 sets forth a flowchart of another example method for enhancing autonomous operation in robotic devices with human intervention according to embodiments of the present disclosure;

FIG. 27 sets forth a flowchart of another example method for enhancing autonomous operation in robotic devices with human intervention according to embodiments of the present disclosure;

FIG. 28 sets forth a flowchart of another example method for enhancing autonomous operation in robotic devices with human intervention according to embodiments of the present disclosure;

FIG. 29 sets forth a flowchart of another example method for enhancing autonomous operation in robotic devices with human intervention according to embodiments of the present disclosure;

FIG. 30 sets forth a flowchart of another example method for enhancing autonomous operation in robotic devices with human intervention according to embodiments of the present disclosure; and

FIG. 31 sets forth a flowchart of another example method for enhancing autonomous operation in robotic devices with human intervention according to embodiments of the present disclosure.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

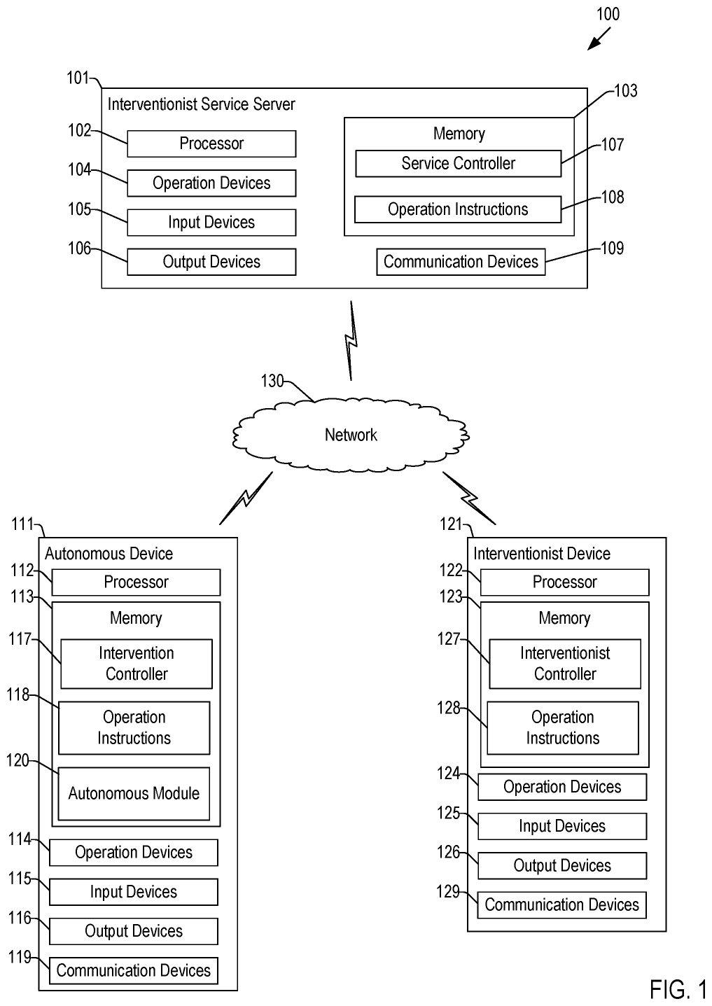

Exemplary methods, apparatuses, and computer program products for enhancing autonomous operation in robotic devices with human intervention in accordance with the present invention are described with reference to the accompanying drawings, beginning with FIG. 1. FIG. 1 sets forth a diagram of a system 100 configured for enhancing autonomous operation in robotic devices with human intervention according to embodiments of the present disclosure. The system 100 of FIG. 1 includes an interventionist service server 101, an autonomous device 111, and an interventionist device 121.

The autonomous device 111 may be any type of device or machine configured for autonomous or semi-autonomous operations and facilitating human intervention according to embodiments of the present disclosure. Examples of autonomous devices include but are not limited to automobiles, air vehicles, drones, robots, and other as will occur to those of skill in the art.

In the example of FIG. 1, the autonomous device 111 includes a processor 112 coupled to a memory 113, communication devices 119, operation devices 114, input devices 115, and output devices 116. Operation devices may include circuitry, hardware, software, or any combination thereof for performing the various operations of the autonomous device. The types of operation devices of an autonomous device may be dependent upon the type of the autonomous device. For example, the operation devices of a UAV may include motors, rotors, and actuators for controlling the flight operations of the UAV. As another example, the operation devices of a manufacturing robot may include wheel controls, swivel controls, cable winding controls, and shovel controls.

The input devices 115 may include circuitry, hardware, software, or any combination thereof for capturing, receiving, or otherwise inputting information into the autonomous device. Examples of input devices include but are not limited to cameras, microphones, keyboards, keypads, touchpads, light sensors, radar, positioning circuitry, pressure sensors, fluid sensors, temperature sensors, accelerometers, wheel speed sensors, gyroscopes, altimeters, and many others as will occur to those of skill in the art.

The input devices 115 are coupled to the processor 112, such that data from the input devices may be available for use by instructions executed by the processor. For example, the input devices may include a camera that is part of a computer vision system. In this example, the camera may capture images or video to be used by the processor during performance of one or more operations, such as a landing operation, a takeoff operation, or object/collision avoidance, as non-limiting examples.

The output devices 116 may include circuitry, hardware, software, or any combination thereof for presenting, displaying, relaying, or otherwise outputting information from the autonomous device. Examples of output devices include but are not limited to display screens, speakers, tactile feedback devices, and many others as will occur to those of skill in the art. The output devices 116 are coupled to the processor 112, such that data from instructions executed by the processor may be related to the output devices.

The communication devices 119 of the autonomous device 111 may include circuitry, hardware, software, or any combination thereof for communicating with another device including, for example, transmitting and receiving data. Examples of communication devices may include but are not limited to wireless and wired devices, such as radio frequency (RF) transceivers, Bluetooth transceivers, ethernet controllers, cellular controllers, and wi-fi controllers. In the example of FIG. 1, the connection between the autonomous device 111 and the network 130 is illustrated as a wireless connection. However, readers of skill in the art will realize that the autonomous device 111 may be coupled to the network 130 or another device via a wired connection.

The memory 113 of the autonomous device 111 includes operation instructions 118 comprising computer program instructions that when executed by the processor 112 cause the processor to control the operation devices 114, the input devices 115, and the output devices 116. For example, if the autonomous device 111 is a UAV, the operation instructions may control flight control operations, such as adjusting the speed of motors and actuators. Continuing with this example, the operation instructions may also control the capturing of video from a camera input device on the UAV and relaying of the captured video via the communication device.

The memory 113 of the autonomous device 111 also includes an autonomous module 120 that includes computer program instructions that when executed by the processor 112 cause the processor 112 to perform instructions/processes/operations autonomously. For example, a robot may include instructions for maneuvering without human intervention.

In the example of FIG. 1, the memory 113 of the autonomous device 111 also includes an intervention controller 117 that includes computer program instructions for enhancing autonomous operation in robotic devices with human intervention. Specifically, the intervention controller 117 includes computer program instructions that when executed by the processor 112 cause the processor 112 to: generate a request in response to detecting an interrupt to an autonomous operation; transmit the request to the interventionist service server; receive a response to the request from the interventionist service server; and perform an operation in accordance with the guidance indicated in the received response.

The interventionist device 121 may be any type of device or machine configured for interfacing with a human and enhancing autonomous operation in robotic devices with human intervention according to embodiments of the present disclosure. Examples of interventionist devices include but are not limited to mobile devices, smartphones, tablets, laptops, computers, touch controllers, keypads, haptic devices, virtual reality (VR) headsets and systems, and others as will occur to those of skill in the art.

In the example of FIG. 1, the interventionist device 121 includes a processor 122 coupled to a memory 123, communication devices 129, operation devices 124, input devices 125, and output devices 126. Operation devices may include circuitry, hardware, software, or any combination thereof for performing the various operations of the interventionist device. The types of operation devices of an interventionist device may be dependent upon the type of the interventionist device.

The input devices 125 may include circuitry, hardware, software, or any combination thereof for capturing, receiving, or otherwise inputting information into the interventionist device. Examples of input devices include but are not limited to cameras, microphones, keyboards, keypads, touchpads, light sensors, radar, positioning circuitry, pressure sensors, fluid sensors, temperature sensors, accelerometers, wheel speed sensors, gyroscopes, altimeters, and many others as will occur to those of skill in the art.

The input devices 125 are coupled to the processor 122, such that data from the input devices may be available for use by instructions executed by the processor. For example, the input devices may include a camera that is part of a computer vision system. In this example, the camera may capture images or video to be used by the processor during performance of one or more operations, such as detecting movement of a human.

The output devices 126 may include circuitry, hardware, software, or any combination thereof for presenting, displaying, relaying, or otherwise outputting information from the interventionist device. Examples of output devices include but are not limited to display screens, speakers, tactile feedback devices, and many others as will occur to those of skill in the art. The output devices 126 are coupled to the processor 122, such that data from instructions executed by the processor may be related to the output devices.

The communication devices 129 of the interventionist device 121 may include circuitry, hardware, software, or any combination thereof for communicating with another device including, for example, transmitting and receiving data. Examples of communication devices may include but are not limited to wireless and wired devices, such as radio frequency (RF) transceivers, Bluetooth transceivers, ethernet controllers, cellular controllers, and wi-fi controllers. In the example of FIG. 1, the connection between the interventionist device 121 and the network 130 is illustrated as a wireless connection. However, readers of skill in the art will realize that the interventionist device 121 may be coupled to the network 130 or another device via a wired connection.

The memory 123 of the interventionist device 121 includes operation instructions 128 comprising computer program instructions that when executed by the processor 122 cause the processor to control the operation devices 124, the input devices 125, and the output devices 126.

In the example of FIG. 1, the memory 123 of the interventionist device 121 also includes an interventionist controller 127 that includes computer program instructions for enhancing autonomous operation in robotic devices with human intervention. Specifically, the interventionist controller 127 includes computer program instructions that when executed by the processor 122 cause the processor 122 to: receive a request from the interventionist service server 101; interface with a human interventionist operator including receiving input; generate a response based on the received input; and transmit the generated response to the interventionist service server 101.

The interventionist service server 101 may be any type of computer, device, or machine configured for communicating with autonomous devices and interventionist devices and enhancing autonomous operation in robotic devices with human intervention according to embodiments of the present disclosure. In the example of FIG. 1, the interventionist service server 101 includes a processor 102 coupled to a memory 103, communication devices 109, operation devices 104, input devices 105, and output devices 106. Operation devices may include circuitry, hardware, software, or any combination thereof for performing the various operations of the interventionist service server.

The input devices 105 may include circuitry, hardware, software, or any combination thereof for capturing, receiving, or otherwise inputting information into the interventionist service server. Examples of input devices include but are not limited to cameras, microphones, keyboards, keypads, touchpads, light sensors, radar, positioning circuitry, pressure sensors, fluid sensors, temperature sensors, accelerometers, wheel speed sensors, gyroscopes, altimeters, and many others as will occur to those of skill in the art. The input devices 105 are coupled to the processor 102, such that data from the input devices may be available for use by instructions executed by the processor.

The output devices 106 may include circuitry, hardware, software, or any combination thereof for presenting, displaying, relaying, or otherwise outputting information from the interventionist service server. Examples of output devices include but are not limited to display screens, speakers, tactile feedback devices, and many others as will occur to those of skill in the art. The output devices 106 are coupled to the processor 102, such that data from instructions executed by the processor may be related to the output devices.

The communication devices 109 of the interventionist service server 101 may include circuitry, hardware, software, or any combination thereof for communicating with another device including for example transmitting and receiving data. Examples of communication devices may include but are not limited to wireless and wired devices, such as radio frequency (RF) transceivers, Bluetooth transceivers, ethernet controllers, cellular controllers, and wi-fi controllers. In the example of FIG. 1, the connection between the interventionist service server 101 and the network 130 is illustrated as a wireless connection. However, readers of skill in the art will realize that the interventionist service server 101 may be coupled to the network 130 or another device via a wired connection.

The memory 103 of the interventionist service server 101 includes operation instructions 108 comprising computer program instructions that when executed by the processor 102 cause the interventionist service server to control the operation devices 104, the input devices 105, and the output devices 106.

In the example of FIG. 1, the memory 103 of the interventionist service server 101 also includes a service controller 107 that includes computer program instructions for enhancing autonomous operation in robotic devices with human intervention. Specifically, the service controller 107 includes computer program instructions that when executed by the processor 102 cause the processor 112 to: receive a request from an autonomous device; determine whether an Autonomy/AI module of the service controller can perform the request autonomously; in response to determining that the Autonomy/AI module can perform the request autonomously, provide the request to the Autonomy/AI module; and generate, by the Autonomy/AI module, an AI response.

The service controller 107 further includes computer program instructions that when executed by the processor 102 cause the processor 112 to: in response to determining that the Autonomy/AI module cannot perform the request autonomously, provide the request to an interventionist module of the service controller; select, by the interventionist module, one or more human interventionists to respond to the request; transmit, by the interventionist module, the request to one or more interventionist devices associated with the selected one or more human interventionists; and receive one or more interventionist responses from the one or more interventionist devices.

In the example of FIG. 1, the service controller 107 also includes computer program instructions that when executed by the processor 102 cause the processor 112 to: determine whether the service controller is sufficiently confident in the generated response (i.e., AI response or interventionist response); in response to determining that the service controller is not sufficiently confident in the generated response, transmit the response to the interventionist module; and in response determining that the service controller is sufficiently confident in the generated response, transmit the generated response to the autonomous device.

In a particular embodiment, the service controller 107 is configured for receiving a request from an autonomous device; determining whether the service controller can perform the request autonomously; in response to determining that the service controller cannot perform the request autonomously, selecting from a plurality of human interventionists, a first set of human interventionists to respond to the request; transmitting the request to a first set of interventionist devices associated with the selected first set of human interventionists; and receiving, from the first set of interventionist devices, a first set of interventionist responses to the transmitted request.

In a particular embodiment, the service controller 107 is configured to select from a first plurality of human interventionists a first set of human interventionists to respond to a request associated with an autonomous device; transmit the request to a first set of interventionist devices, each interventionist device of the first set of interventionist devices associated with a particular human interventionist in the first set of human interventionists; and receive from the first set of interventionist devices, a first set of interventionist responses to the request.

In a particular embodiment, the service controller is configured to for each human interventionist of a plurality of human interventionists: transmit a test request to a particular interventionist device associated with a particular human interventionist; receive from the particular interventionist device, a test response to the transmitted test request; and based on the test response, generate a performance metric of the human interventionist; and based on the performance metrics of the human interventionists of the plurality of human interventionists, determine a rating for each human interventionist of the plurality of human interventionists.

The interventionist service server 101, the autonomous device 111, and the interventionist device 121 of FIG. 1 are intended to provide respective examples of an interventionist service server, an autonomous device, and an interventionist device and are not intended to limit the configuration or components of an interventionist service server, an autonomous device, or the interventionist device that may be used in systems for enhancing autonomous operation in robotic devices with human intervention according to embodiments of the present disclosure. For example, in a particular embodiment, the service controller 107 may be implemented in the autonomous device 111. In another embodiment, a plurality of interventionist devices may be coupled to the service controller.

The network 130 may comprise one or more Local Area Networks (LANs), Wide Area Networks (WANs), cellular networks, satellite networks, internets, intranets, or other networks and combinations thereof. The network 130 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (Hypertext Transfer Protocol), and others as will occur to those of skill in the art. Various embodiments of the present invention may be implemented on a variety of hardware platforms in addition to those illustrated in FIG. 1.

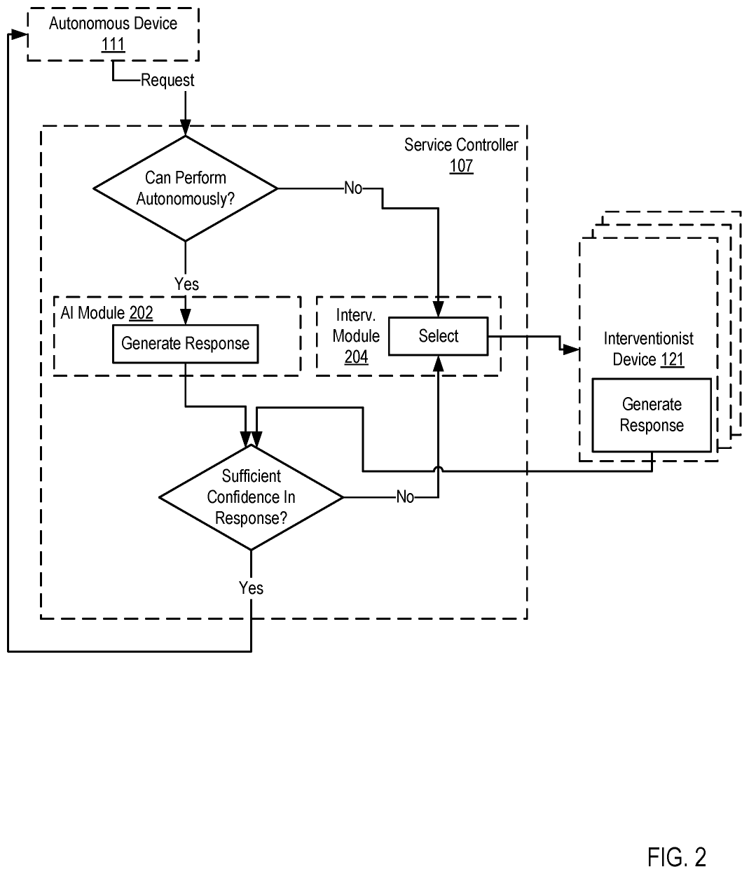

For further explanation, FIG. 2 sets forth a flowchart to illustrate an implementation of a method for enhancing autonomous operation in robotic devices with human intervention according to embodiments of the present disclosure. The method of FIG. 2 includes receiving, by a service controller 107 of an interventionist service server 101, a request from an autonomous device 111.

In a particular embodiment, the service controller may provide to a user/client of the service, a visual programming interface, where a user/client may quickly program/assemble a Request-type. In this example, the user/client may be offered a set of interface types, which they can easily mix and match to build the request that is specific to their task. For instance, a classic robotic assembly task consists of inserting a peg in a hole. This task requires a specific sequence of interface modalities (e.g. different modalities all on a tablet). First, ‘locate the peg’ (where the person draws a ‘loop’ around the peg with a think paint-brush style pencil tool). Second, ‘locate the hole’ (where the person locates the hole). This is a sequence of a ‘pencil’ tool, followed by a pointer-tool, both associated with a written instruction, e.g. ‘locate the hole’. Using these two pieces of info, the robot can complete the task autonomously.

In a particular embodiment, the autonomous device connects to an application programming interface (API) of the interventionist service server. The interventionist service server and the autonomous device may exchange data, such as coordinates. For example, the programming abstraction that is presented to customers/clients may include coordinates=getSingleLocation(object_type, image) [object_type, image are inputs from the autonomous device and sent to the human interventionist, coordinates may be what's returned].

An autonomous device operating in an autonomous mode, may send a request to an interventionist service server for guidance on performing a next step. For example, the autonomous device may be traveling along a path and encounter an obstacle that interrupts the autonomous operation of the autonomous device. In this example, the autonomous device may send a request to the interventionist service server asking for guidance.

The method of FIG. 2 includes in response to receiving the request, determining, by the service controller, whether an autonomy/AI module 202 of the service controller can perform the request autonomously. In response to determining that the autonomy/AI module 202 can perform the request autonomously, the method of FIG. 2 includes the service controller providing the request to the autonomy/AI module 202 for processing. In response to providing the autonomy/AI module 202 the request, the autonomy/AI module generates an autonomous/AI response. The autonomy/AI module may also be configured to perform general training/learning to adapt future responses based on the responses generated by the autonomy/AI module and the responses generated by the human interventionist. In a particular embodiment, the priority or weight applied to the generated responses in the learning process may be based on various factors including but not limited to the qualifications of the selected human interventionist; the type of the interventionist device; and the urgency of the request.

In response to determining that the autonomy/AI module 202 cannot perform the request autonomously, the method of FIG. 2 includes the service controller providing the request to an interventionist module 204. The method of FIG. 2 also includes the interventionist module 204 in response to receiving the request, selecting one or more human interventionists to process the request. Selecting one or more human interventionists may be carried out by selecting, from a plurality of human interventionists having associated interventionist devices, a set of human interventionists based on the qualifications of the human interventionists; costs of using the human interventionists; availability of the human interventionists; urgency of the request; type of interventionist devices associated with the human interventionists; and quality, speed, bandwidth of the connection to the various interventionist device. In a particular embodiment, the service controller is configured to receive an updated request. In this case, the service controller's interventionist module may change a selection of the human interventionist based on the data in the updated request.

In a particular embodiment, human interventionists are benchmarked/ranked against other humans and/or the autonomy/AI module, with respect to different request types and interfaces. The benchmarking or rating information may be used to match higher-priority requests (in terms of speed or accuracy) to higher-performing interventionists (in terms of speed or accuracy). Similarly, autonomous devices of clients with a higher budget may be coupled to higher-performing interventionists.

In order to accomplish low-latency (short turnaround) human intervention, the service controller may utilize statistical methods (based on historical data and extrapolation from which) to a) predict person's response time (by task/interface type) and b) connectivity (latency/bandwidth) of the internet connection between the autonomous device and the human interventionist. Combining a and b, the service controller may optimize for rank latency. Requests may be ranked by urgency and assigned to a human interventionist accordingly.

In order to judge whether a human interventionist is readily available to respond to a request, the service controller may read the sensors of the interventionist device associated with the human interventionist and assess if the interventionist device is actively being used or accessible by the interventionist (e.g., in the interventionist's hand). Alternatively, the service controller can determine whether the person is online by having him/her operate on simulated data.

The method of FIG. 2 includes the interventionist module 204 transmitting the request to an interventionist device 121 associated with the selected human interventionist. In response to receiving the request, the interventionist device presents the request to the human interventionist. The method of FIG. 2 also includes the interventionist device receiving input from the human interventionist in response to representing the request. In the method of FIG. 2, the interventionist device generates and provides to the service controller, based on the received input, an interventionist response to the request. For example, in the case where an autonomous device is traveling along a path and is stuck when it encounters an obstacle, a human interventionist may use the interface of the interventionist device to provide a solution. In this example, the solution may be providing coordinates for traveling around the obstacle.

The method of FIG. 2 includes the service controller 107 determining whether the service controller has sufficient confidence in a generated response (i.e., the autonomous/AI response and the interventionist response). Certain interventions (perhaps for human-safety critical tasks) may require high accuracy/confidence. In order to increase confidence, the service controller may distribute a single request to multiple human interventionists. Using statistical methods, the service controller may return intervention data with higher confidence, together with a statistical metric for this confidence (e.g. with 95% confidence, the true object location lies within the selected circle/sphere).

In response to determining that the service controller 107 does not have sufficient confidence in the generated response, the service controller sends an instruction to the interventionist module 204 to select one or more human interventionists. If the interventionist module had selected a first set of interventionists to respond to the request, the interventionist module may select another set of interventionists to respond to the request.

In response to determining that the service controller 107 does have sufficient confidence in the generated response, the service controller transmits the generated response (i.e., the autonomous/AI response or the interventionist response) to the autonomous device 111.

The method of FIG. 2 also includes the autonomous device 111 receiving the generated response. In response to receiving the generated response, the autonomous device 111 performs an operation in accordance with the generated response. For example, a human interventionist may generate a response that points out the landing spot of an aerial drone by clicking on a table interventionist device. As another example, a shopping-isle scanning robot issues pictures to a human interventionist via the interventionist service server and the interventionist visually assesses fill-states (e.g. 60% full) through an interface on a smart phone interventionist device. As another example, a human operator, through a game pad interventionist device interface, frees a ground delivery drone that is stuck at an obstacle.

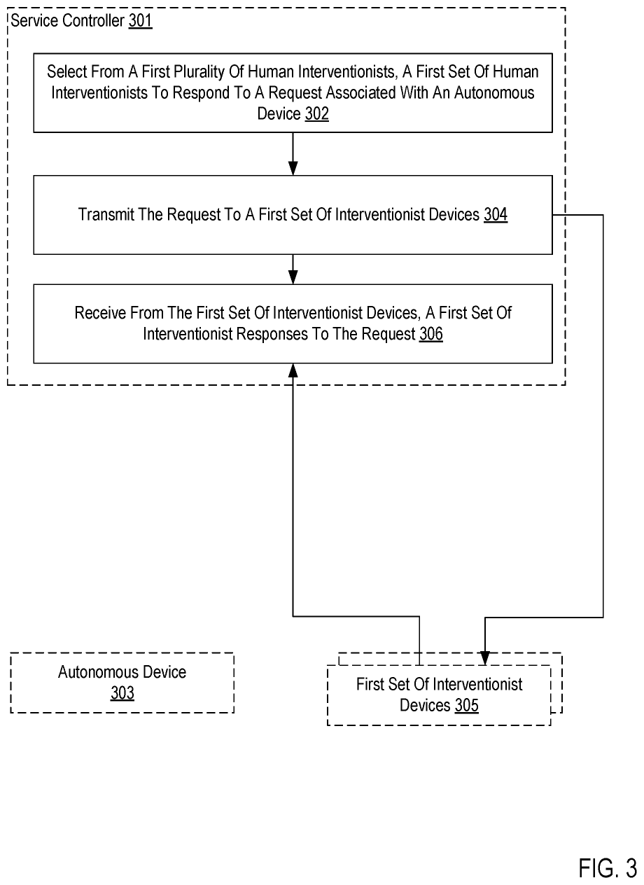

For further explanation, FIG. 3 sets forth a flow chart illustrating an exemplary method for enhancing autonomous operation in robotic devices with human intervention according to embodiments of the present disclosure. The method of FIG. 3 includes selecting 302 from a first plurality of human interventionists, by a service controller 301, a first set of human interventionists to respond to a request associated with an autonomous device 303. A service controller is circuitry, hardware, software, or some combination thereof for facilitating human intervention. In a particular embodiment, the service controller 301 is an example of the service controller 107 of FIG. 1. As explained above, a service controller may be located on a server or device that is remote from the autonomous device or alternatively, may be located within the autonomous device. A request may be a message from the autonomous device that specifies information regarding the autonomous device. In a particular embodiment, a request is generated by the service controller based on information received from the autonomous device. Examples of the types of information that the request may include but are not limited to: an operational status of the autonomous device (e.g., on/off; stuck message; error message; alarm codes/messages; damaged equipment; etc.), an instruction/routine/process indication (e.g., right movement loop), a last step/operation/task/behavior performed (e.g., turned left; shutdown rotor), a plurality of decision choices (e.g., menu choices—identify objects as (a), (b), or (c)), a type of behavior/task that is required to perform (e.g., provide coordinates; guide robot movement), urgency indication (e.g. respond to five minutes), criteria for selecting a human interventionist (e.g., need a doctor; need a mechanic; need a level 8 technician; need lowest cost, available technician that can do level 7 operation on robot); and others as will occur to those of skill in the art after reading the subject disclosure.

Selecting 302 from a first plurality of human interventionists, by a service controller 301, a first set of human interventionists to respond to a request associated with an autonomous device 303 may be carried out by identifying another set of human interventionists that best satisfy the selection criteria that is specified by the service controller or the request. A set of human interventionists may include one or more human interventionists. A human interventionist is a human person that operates an interventionist device. As will be explained below, the selection criteria may include one or more metrics, conditions, or requirements. Examples of the type of data in a selection criteria may include but are not limited to: requirements of the request, such as urgency, priority, difficulty, expense range; and the profiles of the human interventionists which may include information, such as type of interventionist devices associated with the interventionists and ratings of the interventionists according to various metrics, such as performance metrics, qualification, expense, and availability.

The method of FIG. 3 also includes transmitting 304, by the service controller 301, the request to a first set 305 of interventionist devices, where each interventionist device of the first set of interventionist devices is associated with a particular human interventionist in the first set of human interventionists. Transmitting 304, by the service controller 301, the request to a first set 305 of interventionist devices may be carried out by modifying the request by reformatting, adding data, or removing data from the request; and sending the request via a wireless or wired communication network or connection to the interventionist device. For example, the request may be transmitted via an API, as an email, a text message, a link to a network location, and any other electronic means of relaying information from one device to another device.

The method of FIG. 3 also includes receiving 306 from the first set 305 of interventionist devices, by the service controller 301, a first set of interventionist responses to the request. Receiving 306 from the first set 305 of interventionist devices, by the service controller 301, a first set of interventionist responses to the request may be carried out by receiving data via a wireless or wired communication network or connection to the interventionist device.

As explained above, an autonomous device may be a device that performs some behaviors or tasks in an autonomous manner, without requiring human control or direction. While the autonomous device may perform an operation in an autonomous manner, the autonomous device may determine that the instructions/routines/processes of the autonomous device are incapable of identifying a next task to perform with a required degree of certainty or confidence. In this example, the autonomous device may transmit a request for help from a service controller (e.g., the service controller 107 of the interventionist service server 101 of FIG. 1). The service controller may include instructions/routines/processes that can identify autonomously a next task to perform with the required degree of certainty or confidence. In some situations, the service controller may determine that the instructions/routines/processes cannot autonomously identify the next task to perform. In response to determining that the service controller cannot identify the next task to perform, the service controller may select a human interventionist for performing the request of the autonomous device.

In a particular embodiment, the service controller may not include an AI or autonomous module with instructions/routines/processes for autonomously identifying the next task to perform. Without an AI or autonomous module to identify the next task to perform, the service controller may be configured to select one or more human interventionists for performing the request of the autonomous device.

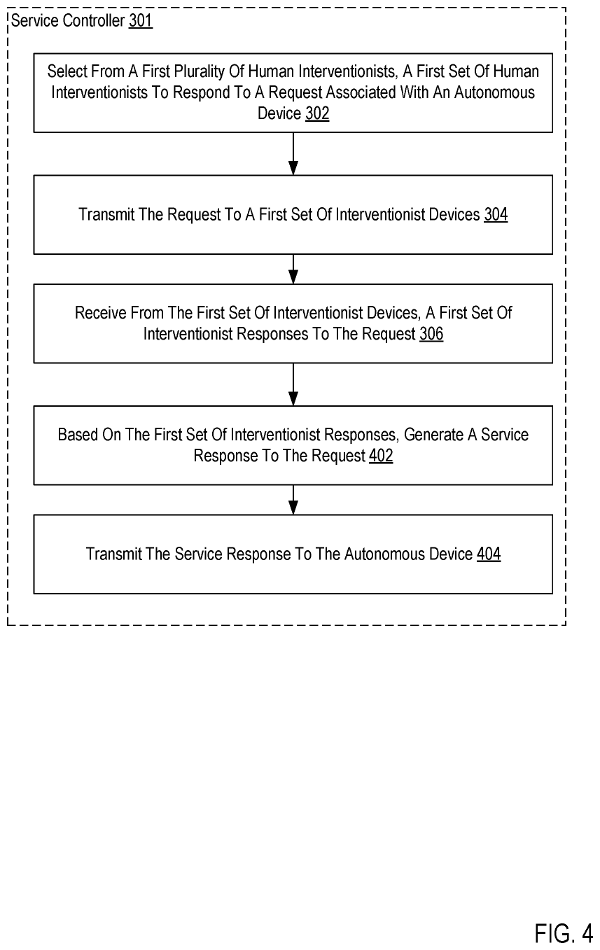

For further explanation, FIG. 4 sets forth a flow chart illustrating an exemplary method for enhancing autonomous operation in robotic devices with human intervention according to embodiments of the present disclosure. The method of FIG. 4 is similar to the method of FIG. 3 in that the method of FIG. 4 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, the method of FIG. 4 includes based on the first set of interventionist responses, generating 402, by the service controller 301, a service response to the request. Generating 402 based on the first set of interventionist responses, by the service controller 301, a service response to the request may be carried out by using the first set of responses to create the service response; averaging the responses; and modifying the responses by reformatting, adding data, or removing data from the response. For example, a set of twelve responses may include ten responses indicating a first selection and two responses indicating a second selection. In this example, the service controller may use the majority response of the first selection as the service response.

In addition, the method of FIG. 4 also includes transmitting 404, by the service controller 301, the service response to the autonomous device 303. Transmitting 404, by the service controller 301, the service response to the autonomous device 303 may be carried out by sending the response via a wireless or wired communication network or connection to the autonomous device. For example, the request may be transmitted via an API, as an email, a text message, a link to a network location, and any other electronic means of relaying information from one device to another device.

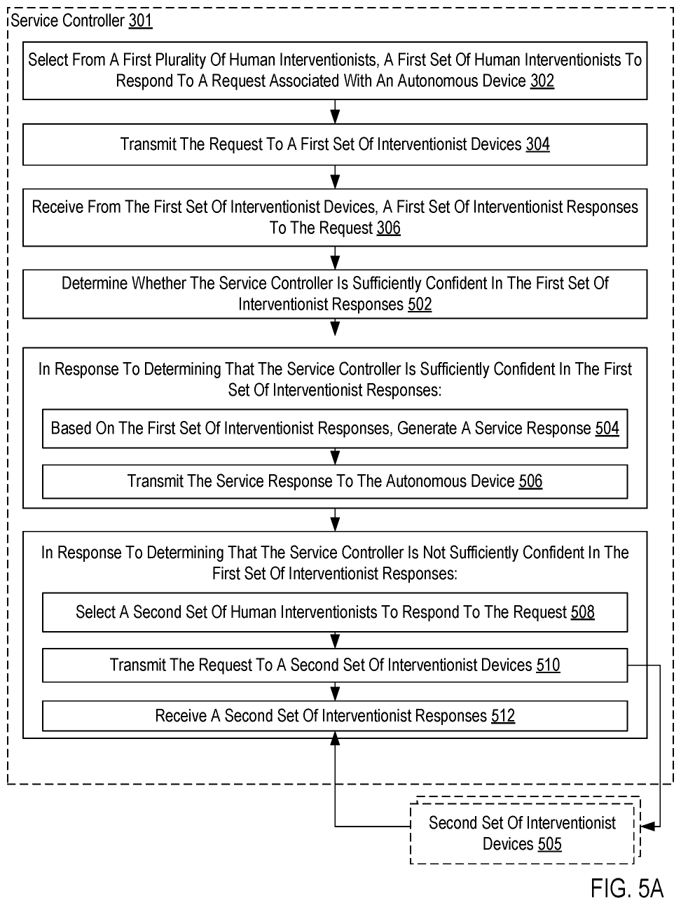

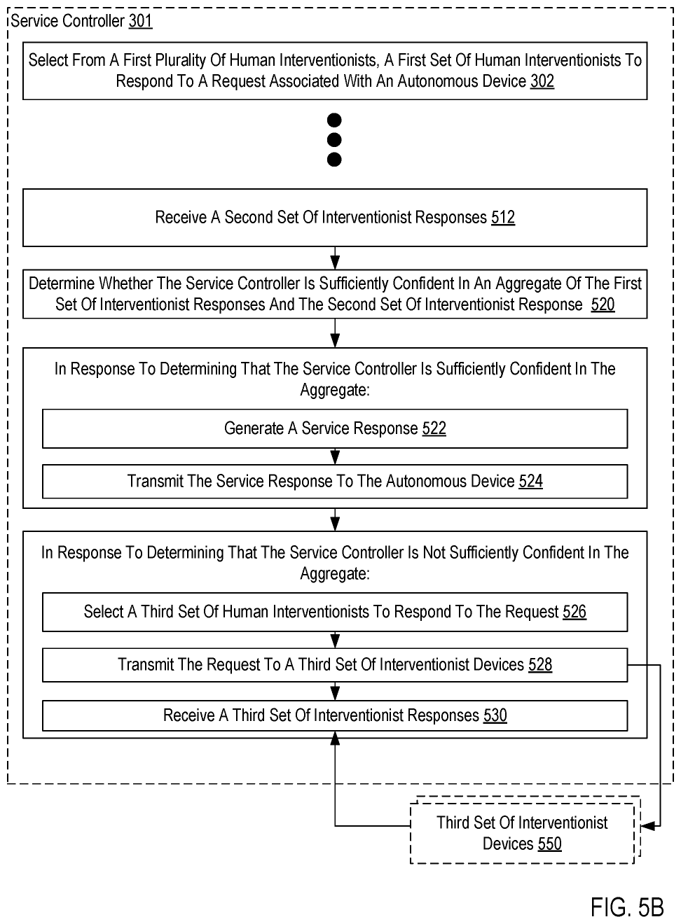

For further explanation, FIG. 5A sets forth a flow chart illustrating an exemplary method for enhancing autonomous operation in robotic devices with human intervention according to embodiments of the present disclosure. The method of FIG. 5A is similar to the method of FIG. 3 in that the method of FIG. 5A also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, the method of FIG. 5A includes determining 502, by the service controller 301, whether the service controller 301 is sufficiently confident in the first set of interventionist responses. Determining 502, by the service controller 301, whether the service controller 301 is sufficiently confident in the first set of interventionist responses may be carried out by determining the confidence threshold requirement associated with the request; and determining whether the first set of human interventionist responses exceeds the confidence threshold. For example, certain interventions (perhaps for human-safety critical tasks) may require high accuracy/confidence. In order to increase confidence, the service controller may distribute a single request to multiple human interventionists. Using statistical methods, the service controller may return intervention data with higher confidence, together with a statistical metric for this confidence (e.g. with 95% confidence, the true object location lies within the selected circle/sphere). However, the returned set of responses may not satisfy the confidence threshold. For example, a confidence threshold may require all responses in the set of responses to indicate the same selection/value/data. Continuing with this example, if two out of twelve interventionist responses indicate a different response, the confidence threshold may be exceeded.

The method of FIG. 5A also includes in response to determining that the service controller 301 is sufficiently confident in the first set of interventionist responses, generating 504, by the service controller 301, a service response to the request. Generating 504, by the service controller 301, a service response to the request may be carried out by using the first set of responses to create the service response, averaging the responses, and modifying the responses by reformatting, adding data, or removing data from the responses to form the service response.

The method of FIG. 5A also includes in response to determining that the service controller 301 is sufficiently confident in the first set of interventionist responses, transmitting 506, by the service controller 301, the first set of interventionist responses to the autonomous device 303. Transmitting 506, by the service controller 301, the first set of interventionist responses to the autonomous device 305 may be carried out by modifying the first set of responses by reformatting, adding data, or removing data from the responses; and sending the service response via a wireless or wired communication network or connection to the autonomous device. For example, the request may be transmitted via an API, as an email, a text message, a link to a network location, and any other electronic means of relaying information from one device to another device.

The method of FIG. 5A also includes in response to determining that the service controller 301 is not sufficiently confident in the first set of interventionist responses: selecting 508 from a second set of human interventionists, by the service controller 301, a second set of human interventionists to respond to the request. In a particular embodiment, the second plurality of human interventionists may include one or more of the human interventionists of the first plurality of human interventionists. However, in a particular embodiment, the second plurality of human interventionists may include a completely different collection of human interventionists. Likewise, the second set of human interventionists may be the same as the first set, completely different from the first set, or include some but not all of the human interventionists of the first set. Selecting 508, by the service controller 301, a second set of human interventionists to respond to the request may be carried out by identifying another set of human interventionists that best satisfy the selection criteria that is specified by the service controller or the request. As will be explained below, the selection criteria may include one or more metrics, conditions, or requirements. Examples of the type of input for a selection criteria may include but are not limited to: requirements of the request, such as urgency, priority, difficulty, expense range; and the profiles of the human interventionists, which may include information such as the types of interventionist devices associated with the interventionists and ratings of the interventionists according to various metrics, such as qualification, expense, availability, responsiveness, and accuracy.

The method of FIG. 5A further includes in response to determining that the service controller 301 is not sufficiently confident in the first set of interventionist responses: transmitting 510, by the service controller 301, the request to a second set of interventionist devices 505, each interventionist device of the second set of interventionist devices associated with a particular human interventionist in the second set of human interventionists. Transmitting 510, by the service controller 301, the request to a second set of interventionist devices 505 associated with the selected set of second human interventionists may be carried out by modifying the request by reformatting, adding data, or removing data from the request; and sending the response via a wireless or wired communication network or connection to the interventionist device. For example, the request may be transmitted via an API, as an email, a text message, a link to a network location, and any other electronic means of relaying information from one device to another device.

In addition, the method of FIG. 5A also includes in response to determining that the service controller 301 is not sufficiently confident in the first interventionist response: receiving 512, by the service controller 301, a second set of interventionist responses from the second set of interventionist devices 505. Receiving 512, by the service controller 301, a second set of interventionist responses from the second set of interventionist devices 505 may be carried out by receiving data via a wireless or wired communication network or connection to the interventionist device.

For further explanation, FIG. 5B sets forth a flow chart illustrating an exemplary method for enhancing autonomous operation in robotic devices with human intervention according to embodiments of the present disclosure. The method of FIG. 5B is similar to the method of FIG. 5A in that the method of FIG. 5B also includes: selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

As in the method of FIG. 5A, the method of FIG. 5B also includes in response to determining that the service controller 301 is sufficiently confident in the first set of interventionist responses, transmitting 506, by the service controller 301, the first set of interventionist responses to the autonomous device 303; and in response to determining that the service controller 301 is not sufficiently confident in the first set of interventionist responses: selecting 508 from a second set of human interventionists, by the service controller 301, a second set of human interventionists to respond to the request; transmitting 510, by the service controller 301, the request to a second set of interventionist devices 505, each interventionist device of the second set of interventionist devices associated with a particular human interventionist in the second set of human interventionists; receiving 512, by the service controller 301, a second set of interventionist responses from the second set of interventionist devices 505.

However, unlike the method of FIG. 5A, the method of FIG. 5B includes determining 520, by the service controller 301, whether the service controller is sufficiently confident in an aggregate of the first set of interventionist responses and the second set of interventionist responses. Determining 520, by the service controller 301, whether the service controller is sufficiently confident in an aggregate of the first set of interventionist responses and the second set of interventionist responses may be carried out by determining the confidence threshold requirement associated with the request; and determining whether the aggregate of the first set of human interventionist responses and the second set of human interventionist responses exceeds the confidence threshold. For example, certain interventions (perhaps for human-safety critical tasks) may require high accuracy/confidence. In order to increase confidence, the service controller may distribute a single request to multiple human interventionists. Using statistical methods, the service controller may return intervention data with higher confidence, together with a statistical metric for this confidence (e.g. with 95% confidence, the true object location lies within the selected circle/sphere). However, the returned set of responses may not satisfy the confidence threshold. For example, a confidence threshold may require all responses in the set of responses to indicate the same selection/value/data. Continuing with this example, if two out of twelve interventionist responses indicate a different response, the confidence threshold may be exceeded.

The method of FIG. 5B also includes in response to determining that the service controller is sufficiently confident in the aggregate of the first set of interventionist responses and the second set of interventionist responses: based on the aggregate of the first set of interventionist responses and the second set of interventionist responses, generating 522, by the service controller 301, a service response to the request. Generating 522, by the service controller 301, a service response to the request may be carried out by using the first set of responses and the second set of responses to create the service response, averaging the responses, and modifying the responses by reformatting, adding data, or removing data from the responses to form the service response. For example, the most common response may be selected as the basis for the service response. In another example, the average of the responses may be selected as the basis for the service response.

In addition, the method of FIG. 5B also includes in response to determining that the service controller is sufficiently confident in the aggregate of the first set of interventionist responses and the second set of interventionist responses: transmitting 524, by the service controller 301, the service response to the autonomous device. Transmitting 524, by the service controller 301, the service response to the autonomous device may be carried out by modifying the first set and the second set of responses by reformatting, adding data, or removing data from the responses; and sending the service response via a wireless or wired communication network or connection to the autonomous device. For example, the request may be transmitted via an API, as an email, a text message, a link to a network location, and any other electronic means of relaying information from one device to another device.

The method of FIG. 5B also includes in response to determining that the service controller is not sufficiently confident in the aggregate of the first set of interventionist responses and the second set of interventionist responses: selecting 526 from a third plurality of human interventionists, by the service controller 301, a third set of human interventionists to respond to the request. In a particular embodiment, the third plurality of human interventionists may include one or more of the human interventionists of the first/second plurality of human interventionists. However, in a particular embodiment, the third plurality of human interventionists may include a completely different collection of human interventionists. Likewise, the third set of human interventionists may be the same as the first/second set, completely different from the first/second set, or include some but not all of the human interventionists of the first/second set. Selecting 526 from a third plurality of human interventionists, by the service controller 301, a third set of human interventionists to respond to the request may be carried out by identifying another set of human interventionists that best satisfy the selection criteria that is specified by the service controller or the request. As will be explained below, the selection criteria may include one or more metrics, conditions, or requirements. Examples of the type of input for a selection criteria may include but are not limited to: requirements of the request, such as urgency, priority, difficulty, expense range; and the profiles of the human interventionists, which may include information such as the types of interventionist devices associated with the interventionists and ratings of the interventionists according to various metrics, such as qualification, expense, availability, responsiveness, and accuracy.

In addition, the method of FIG. 5B also includes in response to determining that the service controller is not sufficiently confident in the autonomous response: transmitting 528, by the service controller 301, the request to a third set of interventionist devices 550, each interventionist device of the third set of interventionist devices associated with a particular human interventionist in the third set of human interventionists. Transmitting 528, by the service controller 301, the request to a third set of interventionist devices, each interventionist device of the third set of interventionist devices associated with a particular human interventionist in the third set of human interventionists may be carried out by modifying the request by reformatting, adding data, or removing data from the request; and sending the response via a wireless or wired communication network or connection to the interventionist device. For example, the request may be transmitted via an API, as an email, a text message, a link to a network location, and any other electronic means of relaying information from one device to another device.

Finally, the method of FIG. 5B also includes in response to determining that the service controller is not sufficiently confident in the autonomous response: receiving 530, by the service controller 301, a third set of interventionist responses from the third set of interventionist devices. Receiving 530, by the service controller 301, a third set of interventionist responses from the third set of interventionist devices may be carried out by receiving data via a wireless or wired communication network or connection to the interventionist device.

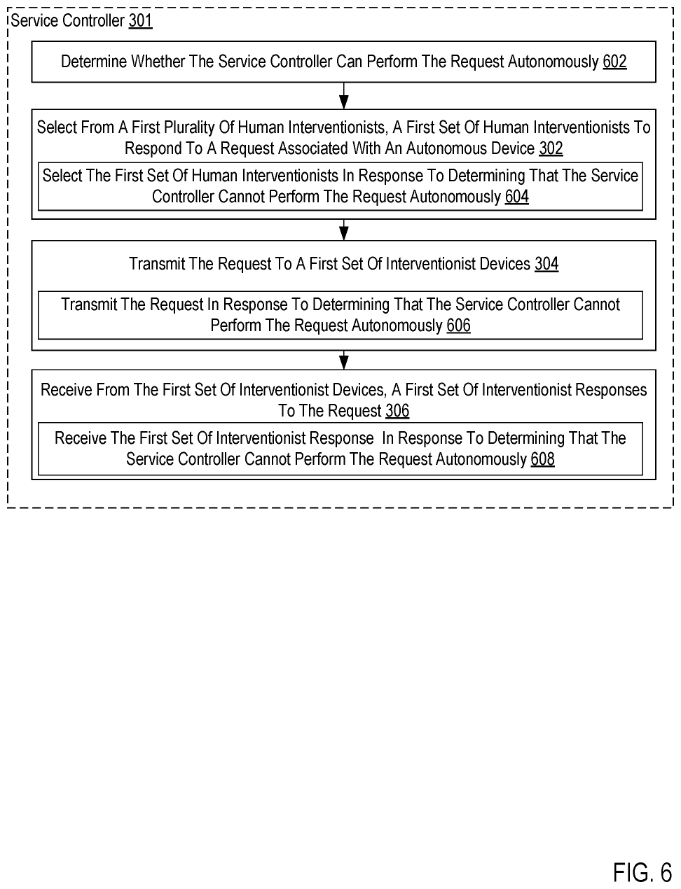

For further explanation, FIG. 6 sets forth a flow chart illustrating an exemplary method for enhancing autonomous operation in robotic devices with human intervention according to embodiments of the present disclosure. The method of FIG. 6 is similar to the method of FIG. 3 in that the method of FIG. 6 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, the method of FIG. 6 includes determining 602, by the service controller 301, whether the service controller 301 can perform the request autonomously. Performing the request autonomously may include deciding a particular action to perform based only on instructions executing on the autonomous device. That is, in this particular example, performing an action autonomously may be carried out without receiving input from a human or another device. Determining 602, by the service controller 301, whether the service controller 301 can perform the request autonomously may be carried out by determining whether the service controller has a historical record of successfully performing this type of request; and determining whether the priority/criterion of the request allows for the service controller to perform this type of request.

In the method of FIG. 6, selecting 302 from a first plurality of human interventionists, by a service controller 301, a first set of human interventionists to respond to a request associated with an autonomous device 303 includes selecting 604 from the first plurality of human interventionists, by the service controller 301, the first set of human interventionists to respond to the request in response to determining that the service controller 301 cannot perform the request autonomously. Selecting 604 from the first plurality of human interventionists, by the service controller 301, the first set of human interventionists to respond to the request in response to determining that the service controller 301 cannot perform the request autonomously may be carried out by identifying the one or more human interventionists that best satisfy a selection criterion/criteria that is specified by the service controller or the request. As will be explained below, the selection criteria may include one or more metrics, conditions, or requirements. Examples of the type of data in a selection criteria may include but are not limited to: requirements of the request, such as urgency, priority, difficulty, expense range; and the profiles of the human interventionists which may include information, such as type of interventionist devices associated with the interventionists and ratings of the interventionists according to various metrics, such as qualification, expense, availability, responsiveness, and accuracy.

In the method of FIG. 6, transmitting 304, by the service controller 301, the request to a first set 305 of interventionist devices includes transmitting 606, by the service controller 301, the request to the first set of interventionist devices in response to determining that the service controller 301 cannot perform the request autonomously. Transmitting 606, by the service controller 301, the request to the first set of interventionist devices in response to determining that the service controller 301 cannot perform the request autonomously may be carried out by modifying the request by reformatting, adding data, or removing data from the request; and sending the request via a wireless or wired communication network or connection to the interventionist device. For example, the request may be transmitted via an API, as an email, a text message, a link to a network location, and any other electronic means of relaying information from one device to another device.

In the method of FIG. 6, receiving 306 from the first set 305 of interventionist devices, by the service controller 301, a first set of interventionist responses to the request includes receiving 608 from the first set of interventionist devices, by the service controller 301, the first set of interventionist responses to the request in response to determining that the service controller 301 cannot perform the request autonomously. Receiving 608 from the first set of interventionist devices, by the service controller 301, the first set of interventionist responses to the request in response to determining that the service controller 301 cannot perform the request autonomously may be carried out by receiving data via a wireless or wired communication network or connection to the interventionist device.

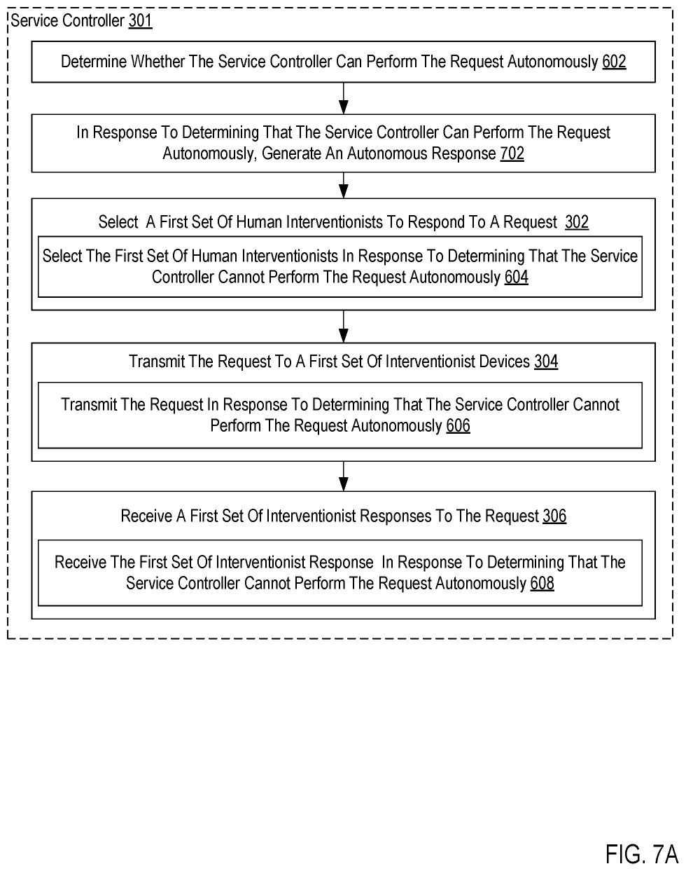

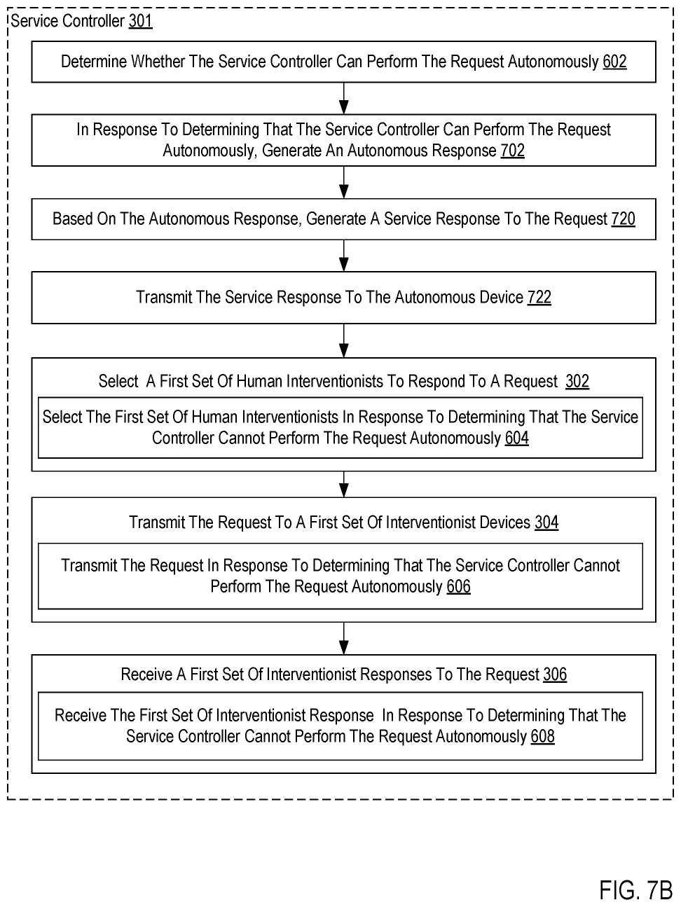

For further explanation, FIG. 7A sets forth a flow chart illustrating an exemplary method for enhancing autonomous operation in robotic devices with human intervention according to embodiments of the present disclosure. The method of FIG. 7A is similar to the method of FIG. 6 in that the method of FIG. 7A also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

Like the method of FIG. 6, the method of FIG. 7A also includes determining 602, by the service controller 301, whether the service controller 301 can perform the request autonomously; selecting 604 from the first plurality of human interventionists, by the service controller 301, the first set of human interventionists to respond to the request is in response to determining that the service controller 301 cannot perform the request autonomously; transmitting 606, by the service controller 301, the request to the first set of interventionist devices is in response to determining that the service controller 301 cannot perform the request autonomously; receiving 608 from the first set of interventionist devices, by the service controller 301, the first set of interventionist responses to the request is in response to determining that the service controller 301 cannot perform the request autonomously.

However, unlike the method of FIG. 6, the method FIG. 7A includes in response to determining that the service controller 301 can perform the request autonomously, generating 702, by the service controller 301, an autonomous response. Generating 702, by the service controller 301, an autonomous response in response to determining that the service controller 301 can perform the request autonomously may be carried out by using autonomous instructions/processes/routines to decide a particular action to perform based only on instructions executing on the service controller. That is, in this particular example, performing an action autonomously may be carried out without receiving input from a human or another device. Deciding a particular action using autonomous instructions/processes/routines may be carried out by using historical decisions from human interventionists, computer simulations, or data from other sources; using instructions/routines/processes to identify patterns in past decisions; calculating probabilities of various solutions producing the correct result, and selecting the highest probability solution.

For further explanation, FIG. 7B sets forth a flow chart illustrating an exemplary method for enhancing autonomous operation in robotic devices with human intervention according to embodiments of the present disclosure. The method of FIG. 7B is similar to the method of FIG. 7A in that the method of FIG. 7B also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

Like the method of FIG. 7A, the method of FIG. 7B also includes determining 602, by the service controller 301, whether the service controller 301 can perform the request autonomously; selecting 604 from the first plurality of human interventionists, by the service controller 301, the first set of human interventionists to respond to the request is in response to determining that the service controller 301 cannot perform the request autonomously; transmitting 606, by the service controller 301, the request to the first set of interventionist devices is in response to determining that the service controller 301 cannot perform the request autonomously; receiving 608 from the first set of interventionist devices, by the service controller 301, the first set of interventionist responses to the request is in response to determining that the service controller 301 cannot perform the request autonomously.

Furthermore, as in the method of FIG. 7A, the method FIG. 7B includes in response to determining that the service controller 301 can perform the request autonomously, generating 702, by the service controller 301, an autonomous response.

However, unlike the method of FIG. 7A, the method of FIG. 7B includes based on the autonomous response, generating 720, by the service controller 301, a service response to the request. Generating 720, by the service controller 301, a service response to the request based on the autonomous response may be carried out by using the autonomous response to create the service response, and modifying the autonomous response by reformatting, adding data, or removing data from the autonomous response.

The method of FIG. 7B also includes transmitting 722, by the service controller 301, the service response to the autonomous device. Transmitting 722, by the service controller 301, the service response to the autonomous device may be carried out by sending the response via a wireless or wired communication network or connection to the autonomous device. For example, the request may be transmitted via an API, as an email, a text message, a link to a network location, and any other electronic means of relaying information from one device to another device.

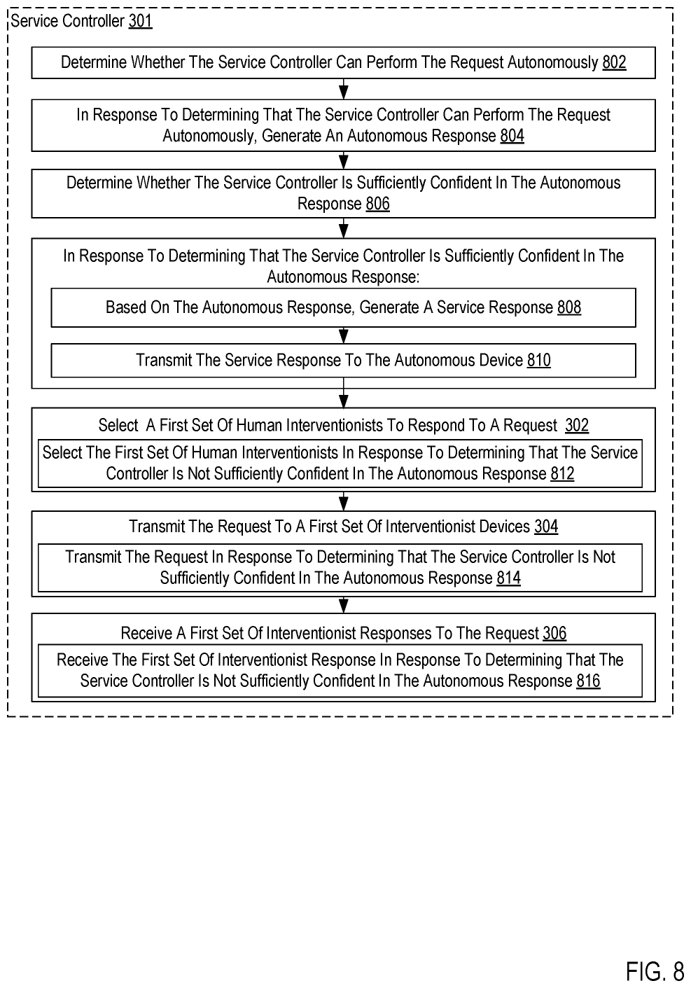

For further explanation, FIG. 8 sets forth a flow chart illustrating an exemplary method for enhancing autonomous operation in robotic devices with human intervention according to embodiments of the present disclosure. The method of FIG. 8 is similar to the method of FIG. 3 in that the method of FIG. 8 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, the method of FIG. 8 includes determining 802, by the service controller 301, whether the service controller can perform the request autonomously. Performing the request autonomously may include deciding a particular action to perform based only on instructions executing on the autonomous device. That is, in this particular example, performing an action autonomously may be carried out without receiving input from a human or another device. Determining 802, by the service controller 301, whether the service controller can perform the request autonomously may be carried out by determining whether the service controller has a historical record of successfully performing this type of request; and determining whether the priority/criterion of the request allows for the service controller to perform this type of request.

The method of FIG. 8 includes in response to determining that the service controller 301 can perform the request autonomously, generating 804, by the service controller 301, an autonomous response. Generating 804, by the service controller 301, an autonomous response in response to determining that the service controller 301 can perform the request autonomously may be carried out by using autonomous instructions/processes/routines to decide a particular action to perform based only on instructions executing on the service controller. That is, in this particular example, performing an action autonomously may be carried out without receiving input from a human or another device. Deciding a particular action using autonomous instructions/processes/routines may be carried out by using historical decisions from human interventionists, computer simulations, or data from other sources; using instructions/routines/processes to identify patterns in past decisions; calculating probabilities of various solutions producing the correct result, and selecting the highest probability solution.

In addition, the method of FIG. 8 includes determining 806, by the service controller 301, whether the service controller is sufficiently confident in the autonomous response. Determining 806, by the service controller 301, whether the service controller is sufficiently confident in the autonomous response may be carried out by determining the confidence threshold requirement associated with the request; and determining whether a single autonomous response exceeds the confidence threshold. For example, certain interventions (perhaps for human-safety critical tasks) may require high accuracy/confidence. As will be explained below, in order to increase confidence, the service controller may distribute a single request to multiple human interventionists. Using statistical methods, the service controller may return intervention data with higher confidence, together with a statistical metric for this confidence (e.g. with 95% confidence, the true object location lies within the selected circle/sphere).

The method of FIG. 8 includes in response to determining that the service controller is sufficiently confident in the autonomous response: based on the autonomous response, generating 808, by the service controller 301, a service response to the request. Generating 808, by the service controller 301, a service response to the request may be carried out by using the autonomous response to create the service response, and modifying the autonomous response by reformatting, adding data, or removing data from the autonomous response.

The method of FIG. 8 includes in response to determining that the service controller is sufficiently confident in the autonomous response: transmitting 810, by the service controller 301, the service response to the autonomous device. Transmitting 810, by the service controller 301, the service response to the autonomous device may be carried out by sending the response via a wireless or wired communication network or connection to the autonomous device. For example, the request may be transmitted via an API, as an email, a text message, a link to a network location, and any other electronic means of relaying information from one device to another device

In the method of FIG. 8, selecting 302 from a first plurality of human interventionists, by a service controller 301, a first set of human interventionists to respond to a request associated with an autonomous device 303 includes in response to determining that that the service controller is not sufficiently confident in the autonomous response, selecting 812 from a first plurality of human interventionists, by a service controller 301, a first set of human interventionists to respond to a request associated with an autonomous device 303. In the method of FIG. 8, transmitting 304, by the service controller 301, the request to a first set 305 of interventionist devices includes in response to determining that that the service controller is not sufficiently confident in the autonomous response, transmitting 814, by the service controller 301, the request to a first set 305 of interventionist devices. In the method of FIG. 8, receiving 306 from the first set 305 of interventionist devices, by the service controller 301, a first set of interventionist responses to the request includes in response to determining that that the service controller is not sufficiently confident in the autonomous response, receiving 816 from the first set 305 of interventionist devices, by the service controller 301, a first set of interventionist responses to the request.

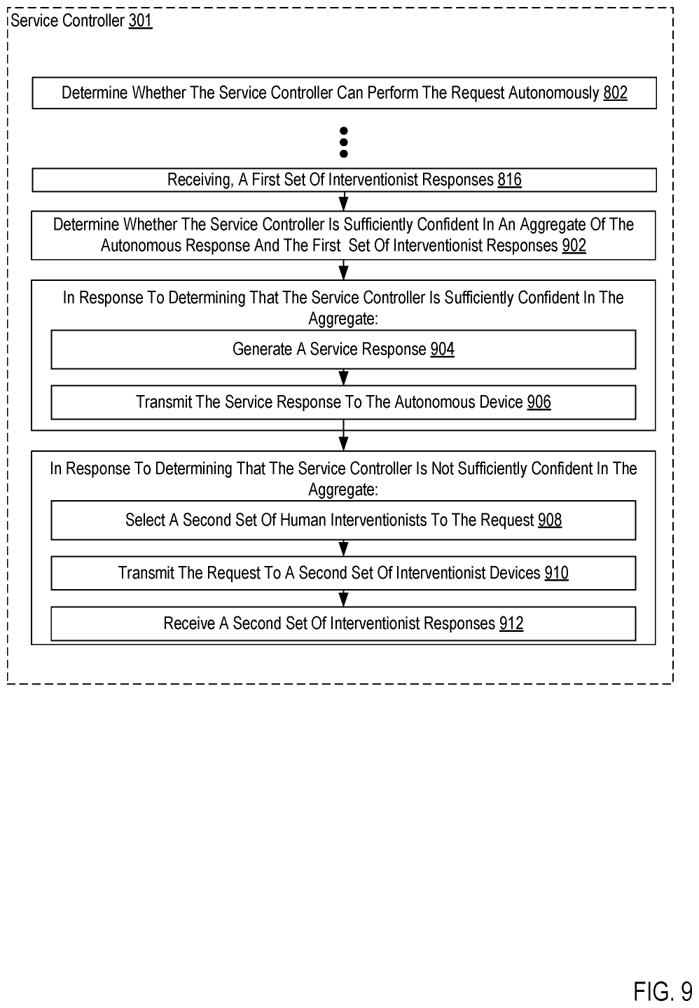

For further explanation, FIG. 9 sets forth a flow chart illustrating an exemplary method for enhancing autonomous operation in robotic devices with human intervention according to embodiments of the present disclosure. The method of FIG. 9 is similar to the method of FIG. 8 in that the method of FIG. 9 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

As in the method of FIG. 8, the method of FIG. 9 also includes determining 802, by the service controller 301, whether the service controller can perform the request autonomously; in response to determining that the service controller 301 can perform the request autonomously, generating 804, by the service controller 301, an autonomous response; determining 806, by the service controller 301, whether the service controller is sufficiently confident in the autonomous response; in response to determining that the service controller is sufficiently confident in the autonomous response: based on the autonomous response, generating 808, by the service controller 301, a service response to the request; and transmitting 810, by the service controller 301, the service response to the autonomous device; in response to determining that that the service controller is not sufficiently confident in the autonomous response, selecting 812 from a first plurality of human interventionists, by a service controller 301, a first set of human interventionists to respond to a request associated with an autonomous device 303; in response to determining that that the service controller is not sufficiently confident in the autonomous response, transmitting 814, by the service controller 301, the request to a first set 305 of interventionist devices; in response to determining that that the service controller is not sufficiently confident in the autonomous response, receiving 816 from the first set 305 of interventionist devices, by the service controller 301, a first set of interventionist responses to the request.

However, unlike the method of FIG. 8, the method of FIG. 9 includes determining 902, by the service controller 301, whether the service controller 301 is sufficiently confident in an aggregate of the autonomous response and the first set of interventionist responses. Determining 902, by the service controller 301, whether the service controller 301 is sufficiently confident in the aggregate of the autonomous response and the first set of interventionist responses may be carried out by determining the confidence threshold requirement associated with the request; and determining whether the aggregate of the autonomous response and the first set of interventionist responses exceeds the confidence threshold.

The method of FIG. 9 includes in response determining that the service controller 301 is sufficiently confident in aggregate of autonomous response and the first set of interventionist responses: based on one of the first set of interventionist responses and the aggregate of the autonomous response and the first set of interventionist responses, generating 904, by the service controller 301, a service response to the request. Generating 904, by the service controller 301, a service response to the request may be carried out by using the aggregate of the autonomous response and the first set of responses to create the service response, averaging the responses, and modifying the responses by reformatting, adding data, or removing data from the response.

The method of FIG. 9 also includes in response determining that the service controller 301 is sufficiently confident in the aggregate of the autonomous response and the first set of interventionist responses: transmitting 906, by the service controller 301, the service response to the autonomous device. Transmitting 906, by the service controller 301, the service response to the autonomous device may be carried out by sending the response via a wireless or wired communication network or connection to the autonomous device.

In addition, the method of FIG. 9 includes in response to determining that the service controller 301 is not sufficiently confident in the aggregate of the autonomous response and the first set of interventionist responses: selecting 908 from a second plurality of human interventionists, by the service controller 301, a second set of human interventionists to respond to the request. In a particular embodiment, the second plurality of human interventionists may include one or more of the human interventionists of the first plurality of human interventionists. However, in a particular embodiment, the second plurality of human interventionists may include a completely different collection of human interventionists. Likewise, the second set of human interventionists may be the same as the first set, completely different from the first set, or include some but not all of the human interventionists of the first set. Selecting 908 from a second plurality of human interventionists, by the service controller 301, a second set of human interventionists to respond to the request may be carried out by identifying another set of human interventionists that best satisfies selection criteria that is specified by the service controller or the request. As will be explained below, the selection criteria may include one or more metrics, conditions, or requirements. Examples of the type of input for a selection criteria may include but are not limited to: requirements of the request, such as urgency, priority, difficulty, expense range; and the profiles of the human interventionists which may include information, such as type of interventionist devices associated with the interventionists and ratings of the interventionists according to various metrics, such as qualification, expense, availability, responsiveness, and accuracy.

The method of FIG. 9 includes in response to determining that the service controller 301 is not sufficiently confident in the aggregate of the autonomous response and the first set of interventionist responses: transmitting 910, by the service controller 301, the request to a second set of interventionist devices, each interventionist device of the second set of interventionist devices associated with a particular human interventionist in the second set of human interventionists. Transmitting 910, by the service controller 301, the request to a second set of interventionist devices may be carried out by sending the response via a wireless or wired communication network or connection to the interventionist device. For example, the request may be transmitted via an API, as an email, a text message, a link to a network location, and any other electronic means of relaying information from one device to another device.

The method of FIG. 9 includes in response to determining that the service controller 301 is not sufficiently confident in the aggregate of the autonomous response and the first set of interventionist responses: receiving 912, by the service controller 301, a second set of interventionist responses from the second set of interventionist devices. Receiving 912, by the service controller 301, a second set of interventionist responses from the second set of interventionist devices may be carried out by receiving data via a wireless or wired communication network or connection to the interventionist device.

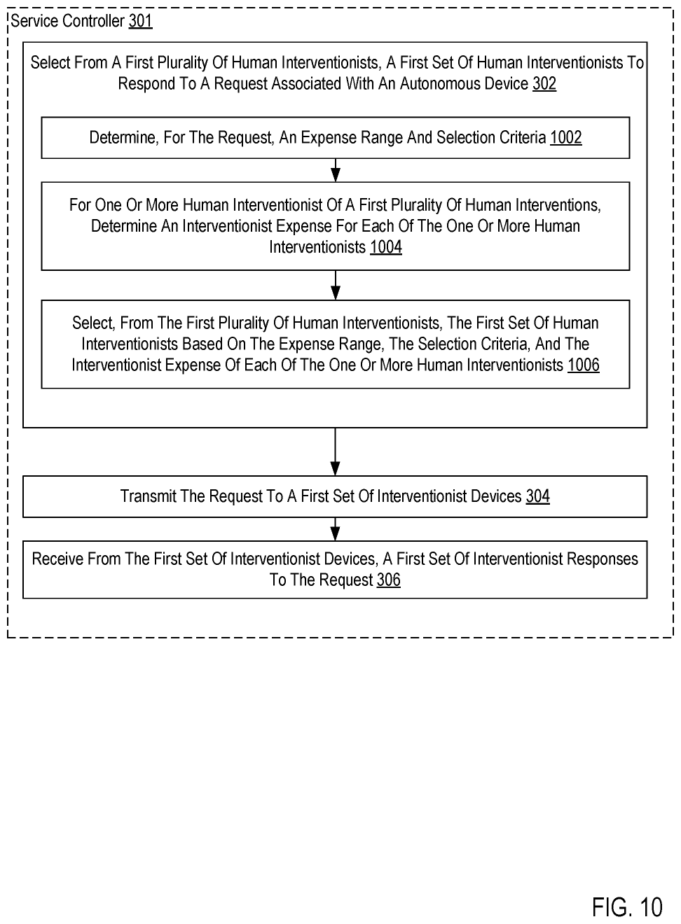

For further explanation, FIG. 10 sets forth a flow chart illustrating an exemplary method for enhancing autonomous operation in robotic devices with human intervention according to embodiments of the present disclosure. The method of FIG. 10 is similar to the method of FIG. 3 in that the method of FIG. 10 includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, in the method of FIG. 10, selecting 302 from a first plurality of human interventionists, by a service controller 301, a first set of human interventionists to respond to a request associated with an autonomous device 303 includes determining 1002, for the request, an expense range and selection criteria. An expense range may specify an acceptable expense for using a human interventionist. Examples of expense range may include but are not limited to a not-to-exceed amount; a billing rate; and a formula for calculating an amount. Selection criteria may specify how the human interventionist is to be selected using the expense range. Determining 1002, for the request, an expense range and selection criteria may be carried out by retrieving from data within the request, the expense range and selection criteria; and using an identifier associated with the request to lookup in a database or data structure, an expense range and selection criteria.

In the method of FIG. 10, selecting 302 from a first plurality of human interventionists, by a service controller 301, a first set of human interventionists to respond to a request associated with an autonomous device 303 includes for one or more human interventionists of the first plurality of human interventionists, determining 1004 an interventionist expense for each of the one or more human interventionists, the interventionist expense indicating the cost of using the human interventionist to respond to the request. Determining 1004 an interventionist expense for each of the one or more human interventionists may be carried out by retrieving the expense from a data structure that specifies the expense of the human interventionist. In a particular embodiment, determining the expense may be carried out by calculating the expense for a human interventionist based on a specific time of the request and the fees associated with the human interventionist performing at the specific time.

In the method of FIG. 10, selecting 302 from a first plurality of human interventionists, by a service controller 301, a first set of human interventionists to respond to a request associated with an autonomous device 303 includes selecting 1006, from the first plurality of human interventionists, the first set of human interventionists based on the expense range, the selection criteria, and the interventionist expense of each of the one or more human interventionists. Selecting 1006, from the first plurality of human interventionists, the first set of human interventionists based on the expense range, the selection criteria, and the interventionist expense of each of the one or more human interventionists may be carried out by identifying the interventionist that best satisfies the selection criteria.

For example, a first human interventionist located in China may charge $100 for requests received between 1:30 GMT to 10:30 GMT and $300 for requests received between 10:30 GMT to 12:30 GMT. Continuing with this example, a second human interventionist located in Canada may charge $200 for requests received between 10:00 GMT to 18:00 GMT. In this example, if a first request is received at 10:15 GMT and the selection criteria requires that the human interventionist having the lowest expense should be selected, the service controller may select the first human interventionist. However, if a second request having the same selection criteria is received at 10:40 GMT, the service controller may select the second human interventionist.

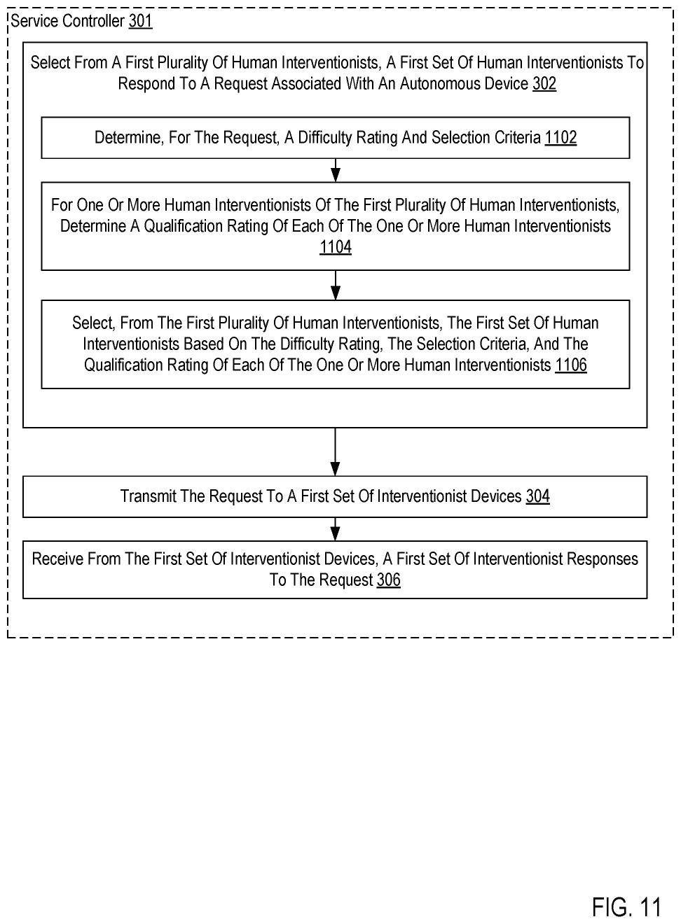

For further explanation, FIG. 11 sets forth a flow chart illustrating an exemplary method for enhancing autonomous operation in robotic devices with human intervention according to embodiments of the present disclosure. The method of FIG. 11 is similar to the method of FIG. 3 in that the method of FIG. 11 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, in the method of FIG. 11, selecting 302 from a first plurality of human interventionists, by a service controller 301, a first set of human interventionists to respond to a request associated with an autonomous device 303 includes determining 1102, for the request, a difficulty rating and selection criteria. A difficulty rating may be an indication of the skills required to respond to the request. Determining 1102, for the request, a difficulty rating and selection criteria may be carried out by retrieving from data within the request, the difficulty rating and selection criteria; using an identifier associated with the request to lookup in a database or data structure, the difficulty rating and selection criteria.

In the method of FIG. 11, selecting 302 from a first plurality of human interventionists, by a service controller 301, a first set of human interventionists to respond to a request associated with an autonomous device 303 includes for one or more human interventionists of the first plurality of human interventionists, determining 1104 a qualification rating of each of the one or more human interventionists. A qualification rating may be an indication of the skills of the human interventionist. Determining 1104 a qualification rating of each of the one or more human interventionists may be carried out by retrieving the qualification rating from a data structure that specifies the rating of the human interventionist.

In the method of FIG. 11, selecting 302 from a first plurality of human interventionists, by a service controller 301, a first set of human interventionists to respond to a request associated with an autonomous device 303 includes selecting 1106, from the first plurality of human interventionists, the first set of human interventionists based on the difficulty rating, the selection criteria, and the qualification rating of the one or more human interventionists. Selecting 1106, from the first plurality of human interventionists, the first set of human interventionists based on the difficulty rating, the selection criteria, and the qualification rating of the one or more human interventionists may be carried out by identifying the interventionist that best satisfies the selection criteria.

In a particular embodiment, the selection criteria may specify selecting the human interventionist having the lowest qualification rating that still satisfies the difficulty rating of the request. For example, a medical robot may send a request for help closing a suture. In this example, the difficult rating may require a qualification rating associated with a nurse level practitioner. Continuing with this example, based on the criteria, the service controller may select a first human interventionist having a qualification rating indicating a nurse level practitioner over a second human interventionist having a qualification rating indicating a surgeon level practitioner. Alternatively, the selection criteria may require selecting the human intervention having the highest qualification rating. As explained above, the qualification rating and difficulty rating may be used in conjunction with other metrics, such as expense, availability, and performance metrics to select a human interventionist.

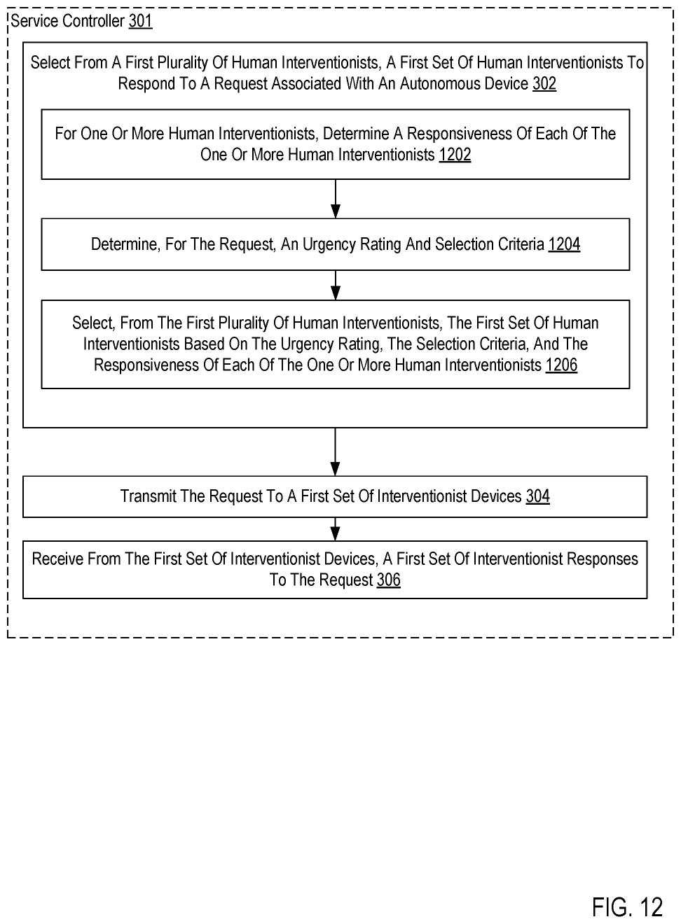

For further explanation, FIG. 12 sets forth a flow chart illustrating an exemplary method for enhancing autonomous operation in robotic devices with human intervention according to embodiments of the present disclosure. The method of FIG. 12 is similar to the method of FIG. 3 in that the method of FIG. 12 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, the method of FIG. 12, selecting 302 from a first plurality of human interventionists, by a service controller 301, a first set of human interventionists to respond to a request associated with an autonomous device 303 includes for one or more human interventionists of the first plurality of human interventionists, determining 1202, by the service controller 301, a responsiveness of each of the one or more human interventionists. Determining 1202, by the service controller 301, a responsiveness of each of the one or more human interventionists may be carried out by using historical data indicating past response times of the human interventionist; and using test results that indicate recent or current responsiveness of the human interventionist. In a particular embodiment, determining 1202, by the service controller 301, a responsiveness of the human interventionist may be carried out by periodically testing a human interventionist by sending sample requests to the human interventionist; measuring the time for the human interventionist to respond; and determining whether the measured time exceeds a threshold. Alternatively, the service controller may measure the signals from the interventionist device to determine whether the human interventionists is active on the device. In this example, the service controller may determine whether the level of activity exceeds a threshold.

In the method of FIG. 12, selecting 302 from a first plurality of human interventionists, by a service controller 301, a first set of human interventionists to respond to a request associated with an autonomous device 303 includes determining 1204, for the request, an urgency rating and selection criteria. Determining 1204, for the request, an urgency rating and selection criteria may be carried out by retrieving from data within the request, the urgency rating and selection criteria; and using an identifier associated with the request to lookup in a database or data structure, an urgency rating and selection criteria.

In the method of FIG. 12, selecting 302 from a first plurality of human interventionists, by a service controller 301, a first set of human interventionists to respond to a request associated with an autonomous device 303 includes selecting 1206, from the first plurality of human interventionists, the first set of human interventionists based on the urgency rating, the selection criteria, and the responsiveness of each of the one or more human interventionists. Selecting 1206, from the first plurality of human interventionists, the first set of human interventionists based on the urgency rating, the selection criteria, and the responsiveness of each of the one or more human interventionists may be carried out by identifying the human interventions that best satisfies the selection criteria.

For example, an urgency rating may specify that a response to the particular request is received within two minutes. In this example, the service controller may determine that two human interventionists have predicted latency values that indicate the human interventionist would respond in under two minutes. The service controller may apply other metrics/criteria to select between the two identified human interventionists. For example, the selection criterion may specify selecting the human interventionist with the highest qualification rating and the lowest expense that meets an urgency latency threshold.

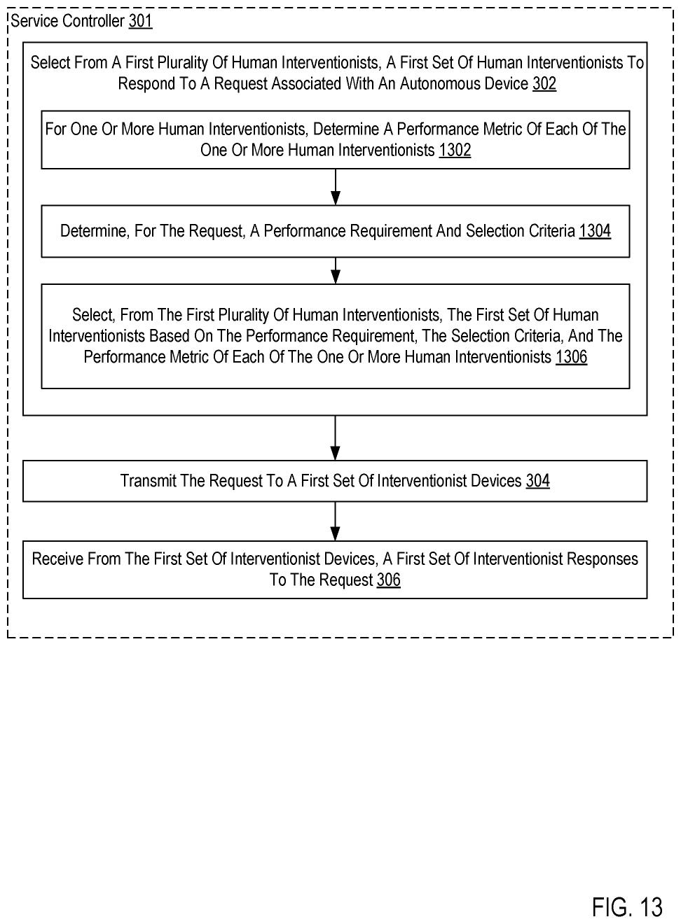

For further explanation, FIG. 13 sets forth a flow chart illustrating an exemplary method for enhancing autonomous operation in robotic devices with human intervention according to embodiments of the present disclosure. The method of FIG. 13 is similar to the method of FIG. 3 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, in the method of FIG. 13, selecting 302 from a first plurality of human interventionists, by a service controller 301, a first set of human interventionists to respond to a request associated with an autonomous device 303 includes for one or more human interventionists of the first plurality of human interventionists, determining 1302, by the service controller 301, a performance metric of each of the one or more human interventionists. A performance metric is an indicator of the performance of a human interventionist. Examples of performance metrics include but are not limited to assessments of latency, responsiveness, bandwidth, accuracy, precision, recall, F−1, and repeatability. Determining 1302, by the service controller 301, a performance metric of the human interventionist may be carried out by examining historical performance of the human interventionists; and periodically testing the human interventionist.

In the method of FIG. 13, selecting 302 from a first plurality of human interventionists, by a service controller 301, a first set of human interventionists to respond to a request associated with an autonomous device 303 includes determining 1304, for the request, a performance requirement and selection criteria. A performance requirement may be an indication of a threshold number associated with a particular type of performance metric. The selection criteria may specify how the human intervention is to be selected using the performance requirement. Determining 1304, for the request, a performance requirement and selection criteria may be carried out by retrieving from data within the request, the performance requirement and selection criteria; and using an identifier associated with the request to lookup in a database or data structure, the performance requirement and selection criteria.

In the method of FIG. 13, selecting 302 from a first plurality of human interventionists, by a service controller 301, a first set of human interventionists to respond to a request associated with an autonomous device 303 includes selecting 1306, from the first plurality of human interventionists, the first set of human interventionists based on the performance requirement, the selection criteria, and the performance metric of each of the one or more human interventionists. Selecting 1306, from the first plurality of human interventionists, the first set of human interventionists based on the performance requirement, the selection criteria, and the performance metric of each of the one or more human interventionists may be carried out by identifying the interventionist that best satisfies the selection criteria.

For example, one performance metric may indicate a score on a test that requires a human intervention to identify objects. In this example, the performance requirement may specify a threshold test score and the selection criteria may specify selecting a human interventionist with a score above the threshold.

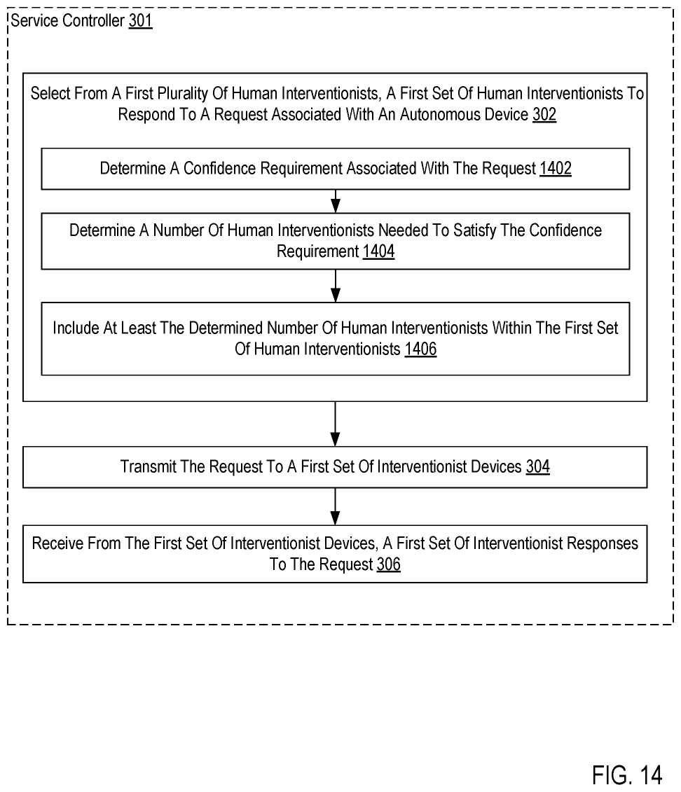

For further explanation, FIG. 14 sets forth a flow chart illustrating an exemplary method for enhancing autonomous operation in robotic devices with human intervention according to embodiments of the present disclosure. The method of FIG. 14 is similar to the method of FIG. 3 in that the method of FIG. 14 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, in the method of FIG. 14, selecting 302 from a first plurality of human interventionists, by a service controller 301, a first set of human interventionists to respond to a request associated with an autonomous device 303 includes determining 1402, by the service controller 301, a confidence requirement associated with the request. In a particular embodiment, performances of human interventionists may be modeled to estimate accuracy and consistency of the human interventionists performing the task. Determining 1402, by the service controller 301, a confidence requirement associated with the request may be carried out by modeling the performance of a group of human interventionists to determine the parameters and qualities of the human interventionists that would be required to perform a particular task with a required level of accuracy and consistency. Examples of modeling methods include but are not limited to means, medians, regressions, probability distributions, mixture models (e.g., Gaussian), Kernel Density Estimation, and clustering.

In the method of FIG. 14, selecting 302 from a first plurality of human interventionists, by a service controller 301, a first set of human interventionists to respond to a request associated with an autonomous device 303 includes determining 1404 a number of human interventionists needed to satisfy the confidence requirement. Determining 1404 a number of human interventionists needed to satisfy the confidence requirement may be carried out by using a model to determine a minimum number of human interventionists for a set of human interventionists to achieve as a group, a desired accuracy and consistency.

In the method of FIG. 14, selecting 302 from a first plurality of human interventionists, by a service controller 301, a first set of human interventionists to respond to a request associated with an autonomous device 303 includes including 1406 at least the determined number of human interventionists within the first set of human interventionists.

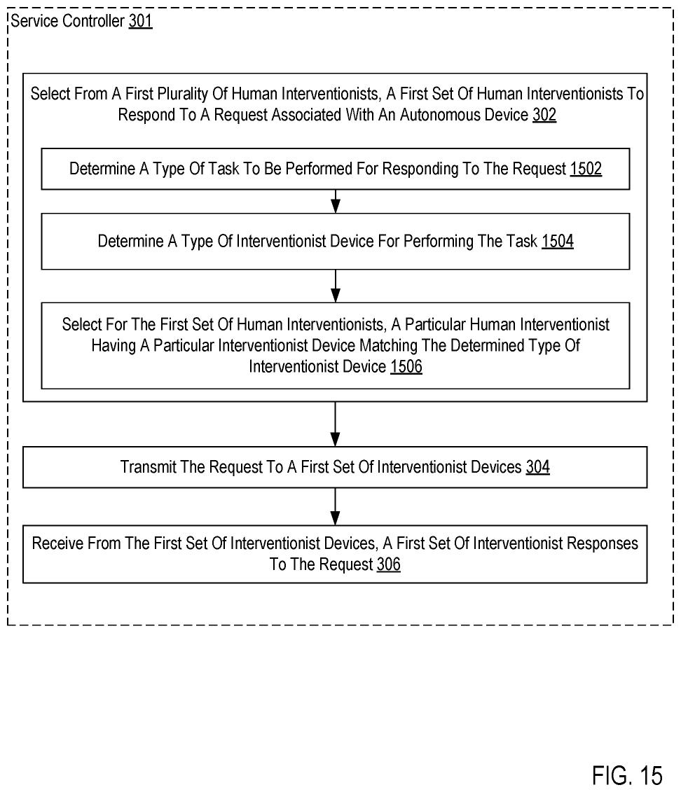

For further explanation, FIG. 15 sets forth a flow chart illustrating an exemplary method for enhancing autonomous operation in robotic devices with human intervention according to embodiments of the present disclosure. The method of FIG. 15 is similar to the method of FIG. 3 in that the method of FIG. 15 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, in the method of FIG. 15, selecting 302 from a first plurality of human interventionists, by a service controller 301, a first set of human interventionists to respond to a request associated with an autonomous device 303 includes determining 1502 a type of task to be performed, by a human interventionist, for responding to the request. Examples of types of tasks to be performed may include but are not limited to identifying an object to select; identifying a location; identifying a label for an object or action; selecting from a plurality of choices, an action or task; identifying a route; selecting from one or more menus; and providing a voice or text message. Determining 1502 a type of task to be performed, by a human interventionist, for responding to the request may be carried out by determining a task code within the request; and analyzing data within the request.

In the method of FIG. 15, selecting 302 from a first plurality of human interventionists, by a service controller 301, a first set of human interventionists to respond to a request associated with an autonomous device 303 includes determining 1504 a type of interventionist device for performing the task. Determining 1504 a type of interventionist device for performing the task may be carried out by matching a task code with an interventionist device code.

In the method of FIG. 15, selecting 302 from a first plurality of human interventionists, by a service controller 301, a first set of human interventionists to respond to a request associated with an autonomous device 303 includes selecting 1506 for the first set of human interventionists, a particular human interventionist having a particular interventionist device matching the determined type of interventionist device. Selecting 1506 for the first set of human interventionists, a particular human interventionist having a particular interventionist device matching the determined type of interventionist device may be carried out by identifying a human interventionist having an associated interventionist device that matches/satisfies the type of required interventionist device.

For example, a request for movement guidance from a medical robot may require a human interventionist to use a specific interventionist device, such as a virtual reality glove, to provide the response. As another example, a request for landing coordinates from a UAV may require a human interventionist to use a joystick as the interventionist device to provide the response.

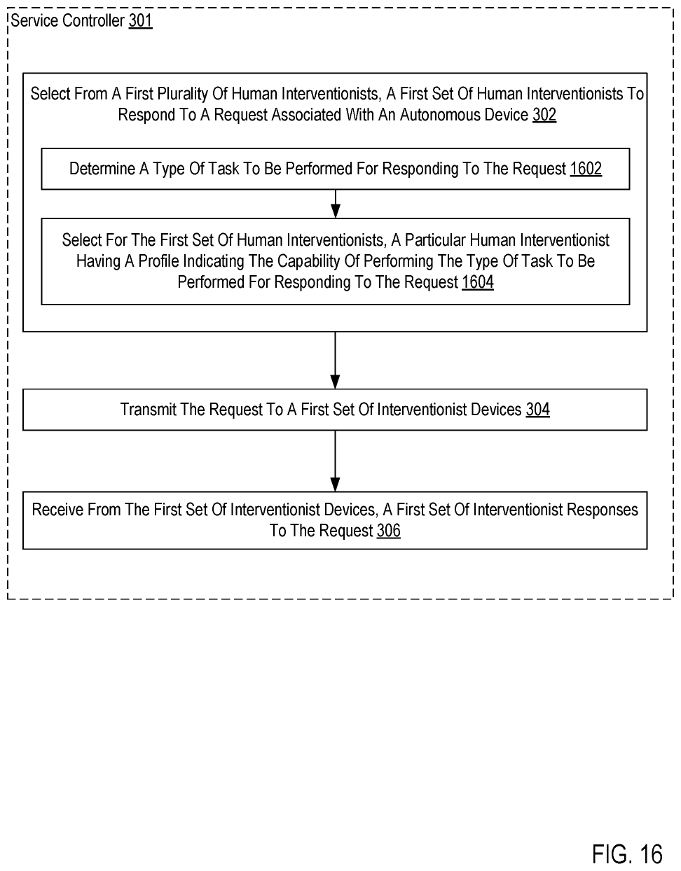

For further explanation, FIG. 16 sets forth a flow chart illustrating an exemplary method for enhancing autonomous operation in robotic devices with human intervention according to embodiments of the present disclosure. The method of FIG. 16 is similar to the method of FIG. 3 in that the method of FIG. 3 is similar to the method of FIG. 16 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

In the method of FIG. 16, selecting 302 from a first plurality of human interventionists, by a service controller 301, a first set of human interventionists to respond to a request associated with an autonomous device 303 includes determining 1602 a type of task to be performed by a human interventionist, for responding the request. Examples of types of tasks to be performed may include but are not limited to identifying an object to select; identifying a location; identifying a label for an object or action; selecting from a plurality of choices, an action or task; identifying a route; selecting from one or more menus; providing a voice or text message. Determining 1602 a type of task to be performed by a human interventionist, for responding the request may be carried out by matching a task code with an interventionist device code.

In the method of FIG. 16, selecting 302 from a first plurality of human interventionists, by a service controller 301, a first set of human interventionists to respond to a request associated with an autonomous device 303 includes selecting 1604 for the first set of human interventionists, a particular human interventionist having a profile indicating the capability of performing the type of task to be performed for responding to the request. Selecting 1604 for the first set of human interventionists, a particular human interventionist having a profile indicating the capability of performing the type of task to be performed for responding to the request may be carried out by examining a profile for an indication that the human interventionist can perform the task or behavior required in the request; and matching the task code with an interventionist skill code in the interventionist's profile.

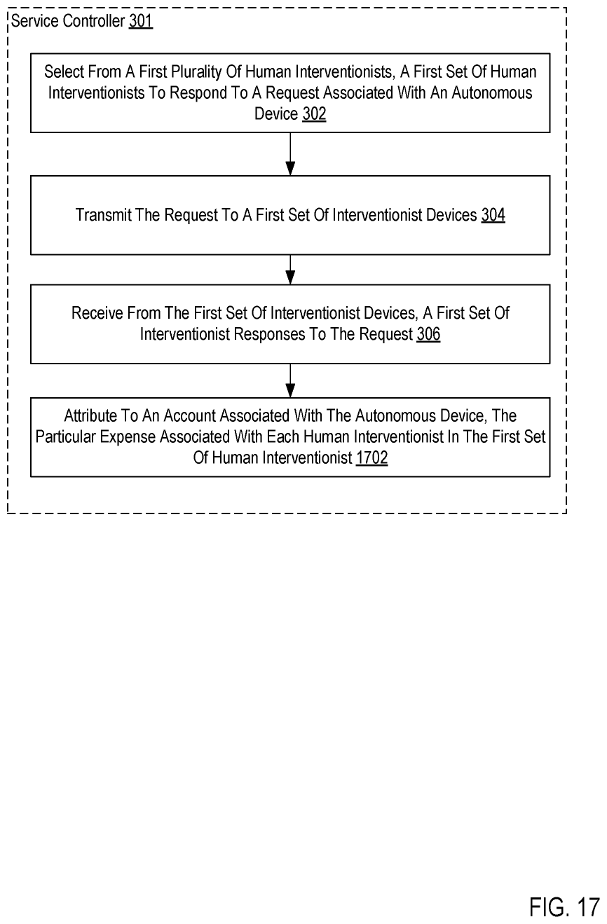

For further explanation, FIG. 17 sets forth a flow chart illustrating an exemplary method for enhancing autonomous operation in robotic devices with human intervention according to embodiments of the present disclosure. The method of FIG. 17 is similar to the method of FIG. 3 also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, the method of FIG. 17 includes attributing 1702 to an account associated with the autonomous device, by the service controller 301, the particular expense associated with each human interventionist in the first set of human interventionists. In a particular embodiment, each human interventionist in the first set of human interventionists has an associated expense for performing a particular type of request. Attributing 1702 to an account associated with the autonomous device, by the service controller 301, the particular expense associated with each human interventionist in the first set of human interventionists may be carried out by calculating the expense of the selected human interventionists and debiting the expense to an account associated with the interventionist device.

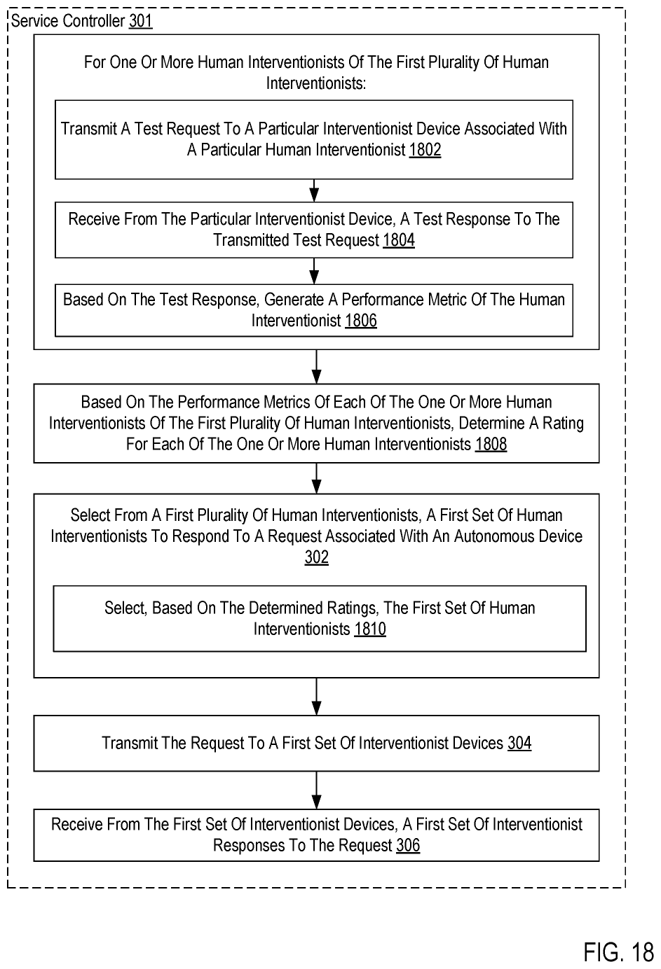

For further explanation, FIG. 18 sets forth a flow chart illustrating an exemplary method for enhancing autonomous operation in robotic devices with human intervention according to embodiments of the present disclosure that includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

The method of FIG. 18 includes for one or more human interventionists in the first plurality of human interventionists: transmitting 1802, by the service controller 301, a test request to a particular interventionist device associated with a particular human interventionist. Transmitting 1802, by the service controller 301, a test request to a particular interventionist device associated with a particular human interventionist may be carried out by sending a historical request to the interventionist device; and sending a sample request to the interventionist device.

The method of FIG. 18 also includes for one or more human interventionists in the first plurality of human interventionists: receiving 1804 from the particular interventionist device, by the service controller 301, a test response to the transmitted test request. Receiving 1804 from the particular interventionist device, by the service controller 301, a test response to the transmitted test request may be carried out by receiving data in response to the request.

The method of FIG. 18 includes for one or more human interventionists in the first plurality of human interventionists: based on the test response, generating 1806, by the service controller 301, a performance metric of the human interventionist. Generating 1806, by the service controller 301, a performance metric of the human interventionist may be carried out by comparing the response to a historical response; comparing the response to a known or preferred solution of the request.

In addition, the method of FIG. 18 also includes based on the performance metrics of each of the one or more human interventionists of the first plurality of human interventionists, determining 1808, by the service controller 301, a rating for each of the one or more human interventionists. Determining 1808, by the service controller 301, a rating for each of the one or more human interventionists may be carried out by sorting the results of the comparisons.

In the method of FIG. 18, selecting 302 from a first plurality of human interventionists, by a service controller 301, a first set of human interventionists to respond to a request associated with an autonomous device 303 includes selecting 1810, based on the determined ratings, the first set of human interventionists. Selecting 1810, based on the determined ratings, the first set of human interventionists may be carried out by identifying and selecting the human interventionist with the rating indicating the lowest latency.

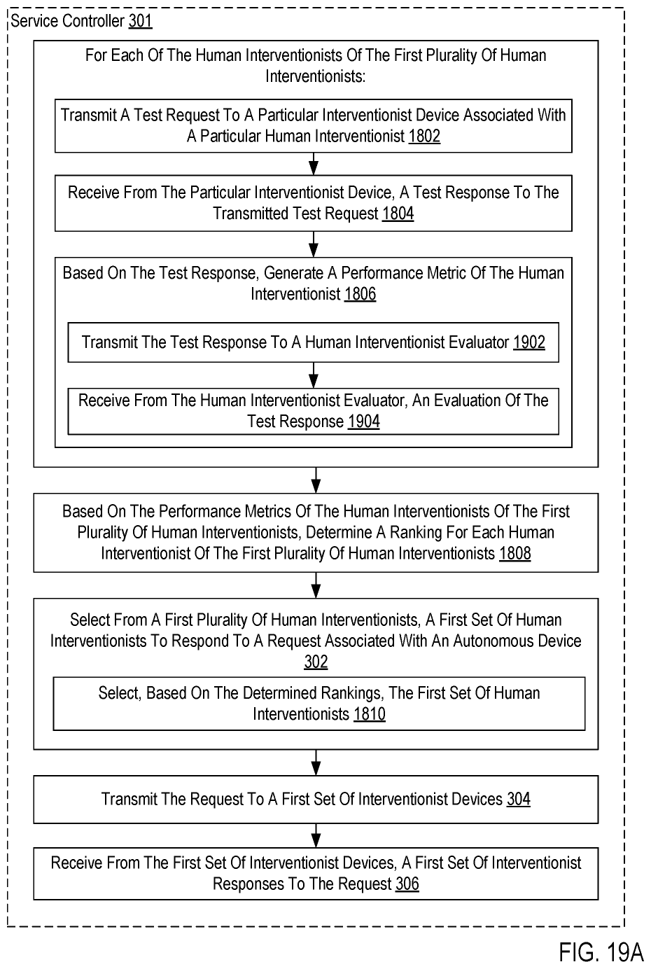

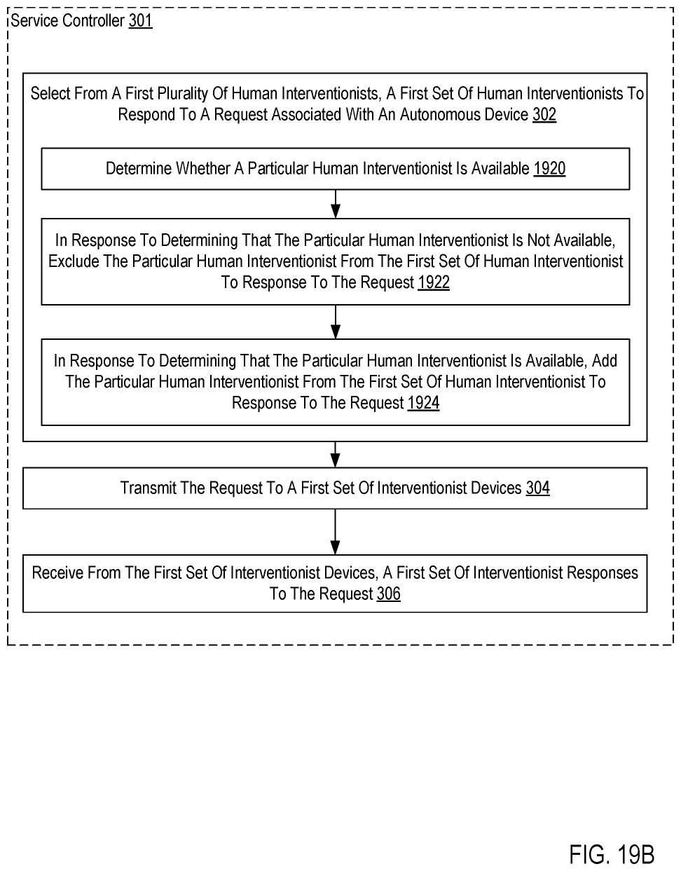

For further explanation, FIG. 19A sets forth a flow chart illustrating an exemplary method for enhancing autonomous operation in robotic devices with human intervention according to embodiments of the present disclosure. The method of FIG. 19A is similar to the method of FIG. 18 in that the method of FIG. 19A also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

As in the method of FIG. 18, the method of FIG. 19A also includes for each of the human interventionists of the first plurality of human interventionists: transmitting 1802, by the service controller 301, a test request to a particular interventionist device associated with a particular human interventionist; receiving 1804 from the particular interventionist device, by the service controller 301, a test response to the transmitted test request; and based on the test response, generating 1806, by the service controller 301, a performance metric of the human interventionist. The method of FIG. 19A also includes based on the performance metrics of the human interventionists of the first plurality of human interventionists, determining 1808, by the service controller 301, a rating for each human interventionist of the first plurality of human interventionists; and selecting 1810, based on the determined ratings, the first set of human interventionists.

However, unlike the method FIG. 18, the method of FIG. 19A includes transmitting 1902 the test response to a human interventionist evaluator. A human intervention evaluator may be a supervisor human interventionist. Alternatively, the human interventionist evaluator may be an autonomous module that includes computer program instructions. Transmitting 1902 the test response to a human interventionist evaluator may be carried out by modifying the test response by reformatting, adding data, or removing data from the test response; and sending the test response via a wireless or wired communication network or connection to the human interventionist evaluator. For example, the request may be transmitted via an API, as an email, a text message, a link to a network location, and any other electronic means of relaying information from one device to another device.

The method of FIG. 19A also includes receiving 1904 from the human interventionist evaluator, an evaluation of the test response. An evaluation of the test response may include a binary decision of whether the human interventionist made the correct decision. The evaluation may also include a determination or indication of the correct or preferred solution. Receiving 1904 from the human interventionist evaluator, an evaluation of the test response may be carried out by receiving data via a wireless or wired communication network or connection to the human interventionist evaluator.

For further explanation, FIG. 19B sets forth a flow chart illustrating an exemplary method for enhancing autonomous operation in robotic devices with human intervention according to embodiments of the present disclosure. The method of FIG. 19B is similar to the method of FIG. 3 in that the method of FIG. 19B also includes selecting 302 from a first plurality of human interventionists, by a service controller 301, a first set of human interventionists to respond to a request associated with an autonomous device 303; transmitting 304, by the service controller 301, the request to a first set 305 of interventionist devices; and receiving 306 from the first set 305 of interventionist devices, by the service controller 301, a first set of interventionist responses to the request.

However, unlike the method of FIG. 3, in the method of FIG. 19B, selecting 302 from a first plurality of human interventionists, by a service controller 301, a first set of human interventionists to respond to a request associated with an autonomous device 303 includes determining 1920, by the service controller 301, whether a particular human interventionist is available. Determining 1920, by the service controller 301, whether a particular human interventionist is available may be carried out by periodically testing a human interventionist by sending sample requests to the human interventionist; measuring the time for the human interventionist to respond; and determining whether the measured time exceeds a threshold. Alternatively, the service controller may measure the signals from the interventionist device to determine whether the human interventionists is active on the device. In this example, the service controller may determine whether the level of activity exceeds a threshold.

The method of FIG. 19B also includes in response to determining that the particular human interventionist is not available, excluding 1922, by the service controller 301, the particular human interventionist from the first set of human interventionists to respond to the request. Excluding 1922, by the service controller 301, the particular human interventionist from the first set of human interventionists to respond to the request may be carried out by removing the human interventionist from the list of human interventionists that are available to be included in the plurality of human interventionists

In addition, the method of FIG. 19B also includes in response to determining that the particular human interventionist is available, adding 1924, by the service controller 301, the particular human interventionist to the first set of human interventionists to respond to the request. Adding 1924, by the service controller 301, the particular human interventionist to the first set of human interventionists to respond to the request may be carried out by adding the human interventionist to the list of human interventionists that are available to be included in the plurality of human interventionists.

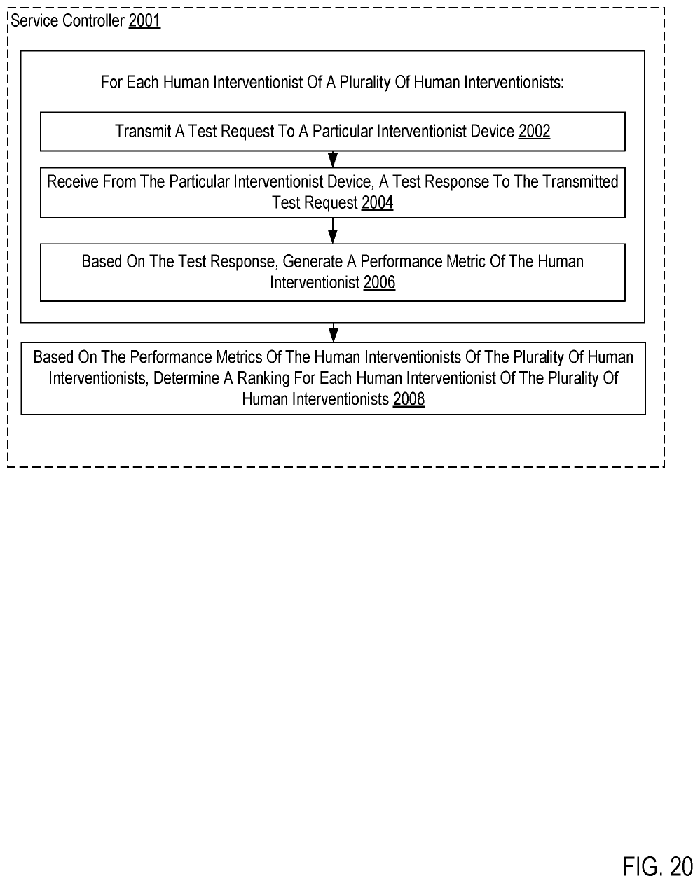

For further explanation, FIG. 20 sets forth a flow chart illustrating an exemplary method for enhancing autonomous operation in robotic devices with human intervention according to embodiments of the present disclosure. The method of FIG. 20 includes for each human interventionist of a plurality of human interventionists: transmitting 2002, by a service controller 2001, a test request to a particular interventionist device associated with a particular human interventionist. Transmitting 2002, by a service controller 2001, a test request to a particular interventionist device associated with a particular human interventionist may be carried out by sending a historical request to the interventionist device; and sending a sample request to the interventionist device.

The method of FIG. 20 includes for each human interventionist of a plurality of human interventionists: receiving 2004 from the particular interventionist device, by the service controller 2001, a test response to the transmitted test request. Receiving 2004 from the particular interventionist device, by the service controller 2001, a test response to the transmitted test request may be carried out by receiving data in response to the request.

In addition, the method of FIG. 20 includes for each human interventionist of a plurality of human interventionists: based on the test response, generating 2006, by the service controller 2001, a performance metric of the human interventionist. Generating 2006, by the service controller 2001, a performance metric of the human interventionist may be carried out by comparing the response to a historical response; and comparing the response to a known or preferred solution of the request.

The method of FIG. 20 includes based on the performance metrics of the human interventionists of the plurality of human interventionists, determining 2008, by the service controller 2001, a rating for each human interventionist of the plurality of human interventionists. Determining 2008, by the service controller 2001, a rating for each human interventionist of the plurality of human interventionists may be carried out by comparing the performance metrics of each human interventionists and sorting the results of the comparison.

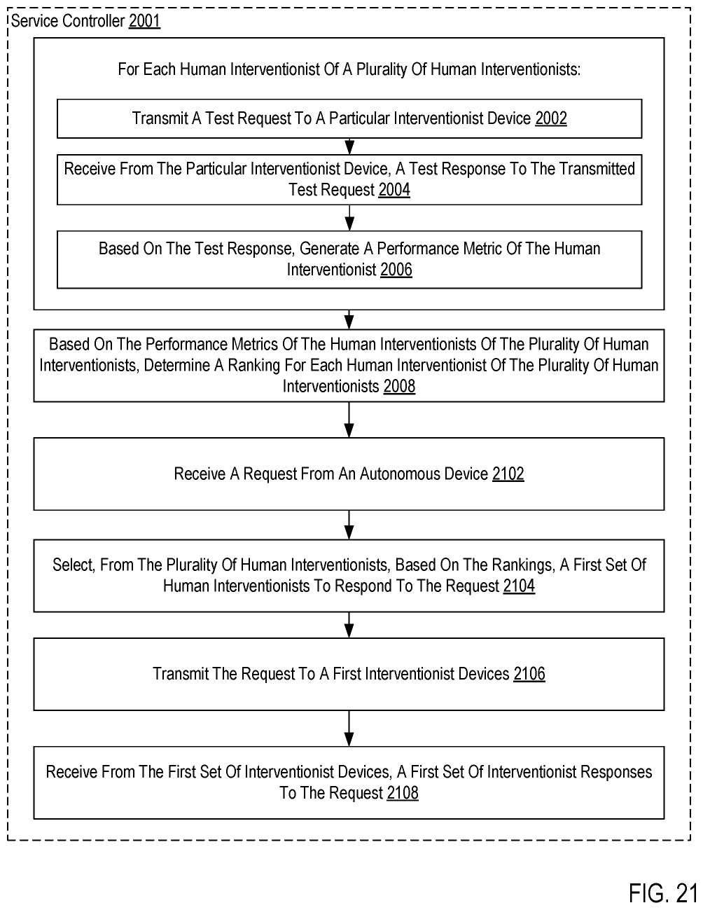

For further explanation, FIG. 21 sets forth a flow chart illustrating an exemplary method for enhancing autonomous operation in robotic devices with human intervention according to embodiments of the present disclosure. The method of FIG. 21 is similar to the method of FIG. 20 in that the method of FIG. 21 also includes for each human interventionist of a plurality of human interventionists: transmitting 2002, by a service controller 2001, a test request to a particular interventionist device associated with a particular human interventionist; receiving 2004 from the particular interventionist device, by the service controller 2001, a test response to the transmitted test request; and based on the test response, generating 2006, by the service controller 2001, a performance metric of the human interventionist. The method of FIG. 21 also includes based on the performance metrics of the human interventionists of the plurality of human interventionists, determining 2008, by the service controller 2001, a rating for each human interventionist of the plurality of human interventionists.

In addition, the method of FIG. 21 also includes receiving 2102, by the service controller 2001, a request from an autonomous device. A request may be a message from the autonomous device that specifies information regarding the autonomous device. Examples of the types of information that the request may include but are not limited to: an operational status of the autonomous device (e.g., on/off; stuck message; error message; alarm codes/messages; damaged equipment; etc.), an instruction/routine/process indication (e.g., right movement loop), a last step/operation/task/behavior performed (e.g., turned left; shutdown rotor), a plurality of decision choices (e.g., menu choices—identify objects as (a), (b), or (c)), a type of behavior/task that is required to perform (e.g., provide coordinates; guide robot movement), urgency indication (e.g. respond to five minutes), criteria for selecting a human interventionist (e.g., need a doctor; need a mechanic; need a level 8 technician; need lowest cost, available technician that can do level 7 operation on robot); and others as will occur to those of skill in the art after reading the subject disclosure. Receiving 2102, by the service controller 301, a request from an autonomous device may be carried out by receiving via wired or wireless communication, a message from the autonomous device.

The method of FIG. 21 also includes selecting 2104 from the plurality of human interventionists, by the service controller 2001, a first set of human interventionists to respond to the request. Selecting 2104 from the plurality of human interventionists, by the service controller 2001, a first set of human interventionists to respond to the request may be carried out by identifying a set of human interventionists that best satisfy the selection criteria that is specified by the service controller or the request.

The method of FIG. 21 also includes transmitting 2106, by the service controller 2001, the request to a first set of interventionist devices, each interventionist device of the first set of interventionist devices associated with a particular human interventionist in the first set of human interventionists. Transmitting 2106, by the service controller 2001, the request to a first set of interventionist devices may be carried out by modifying the request by reformatting, adding data, or removing data from the request; and sending the response via a wireless or wired communication network or connection to the interventionist device. For example, the request may be transmitted via an API, as an email, a text message, a link to a network location, and any other electronic means of relaying information from one device to another device.

The method of FIG. 21 also includes receiving 2108 from the first set of interventionist devices, by the service controller 2001, a first set of interventionist responses to the request. Receiving 2108 from the first set of interventionist devices, by the service controller 2001, a first set of interventionist responses to the request may be carried out by receiving data via a wireless or wired communication network or connection to the interventionist device.

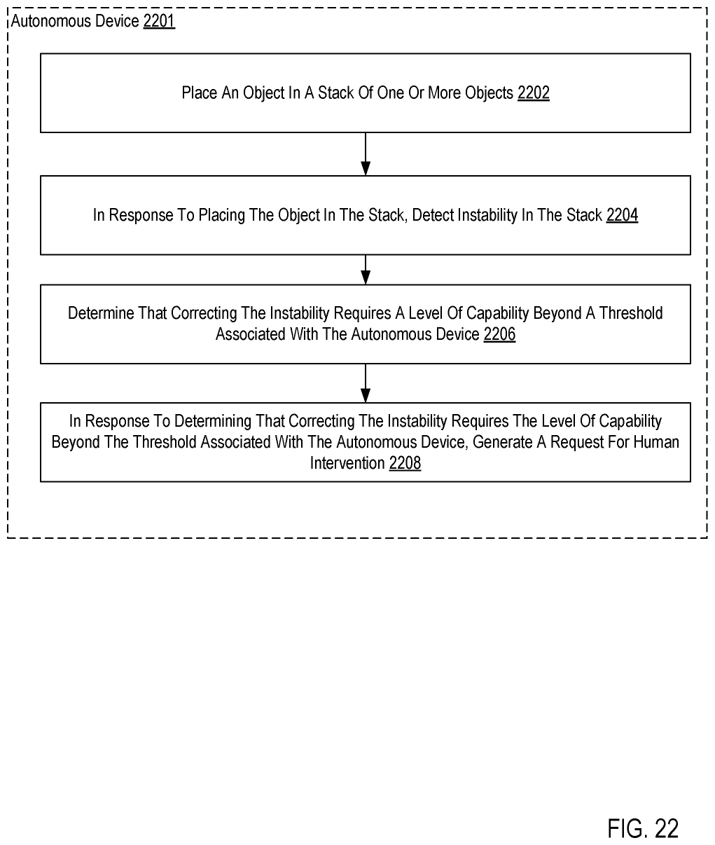

For further explanation, FIG. 22 sets forth a flow chart illustrating an exemplary method for enhancing autonomous operation in robotic devices with human intervention according to embodiments of the present disclosure. The method of FIG. 22 includes placing 2202, by an autonomous device 2201, an object in a stack of one or more objects. Placing 2202, by an autonomous device 2201, an object in a stack of one or more objects may be carried out by using an autonomous process to identify an object to move, determining how to grasp the object, grasping the object using one or components of the autonomous device, identifying a location to place the object, moving the object to the location, and releasing the object.

The method of FIG. 22 also includes in response to placing the object in the stack, detecting 2204, by the autonomous device 2201, instability in the stack. Detecting 2204, by the autonomous device 2201, instability in the stack in response to placing the object in the stack may be carried out by receiving sensor input associated with the object; analyzing the sensor input; comparing the sensor input to historical records, and determining, based on the analysis of the sensor input, that the object or stack is unstable. For example, the autonomous device may determine from pictures of the stack that one or more objects in the stack forms a configuration that historically has shown to be unstable.

In addition, the method of FIG. 22 also includes determining 2206, by the autonomous device 2201, that correcting the instability requires a level of capability beyond a threshold associated with the autonomous device. Determining 2206, by the autonomous device 2201, that correcting the instability requires a level of capability beyond a threshold associated with the autonomous device may be carried out by analyzing a historical record to determine whether the identified unstable configuration has successfully been stabilized by the autonomous device. For example, the autonomous device may determine that the autonomous device has previously attempted unsuccessfully to stabilize this type of stacked configuration.

The method of FIG. 22 also includes in response to determining that correcting the instability requires the level of capability beyond the threshold associated with the autonomous device, generating 2208, by the autonomous device 2201, a request for human intervention. Generating 2208, by the autonomous device 2201, a request for human intervention in response to determining that correcting the instability requires the level of capability beyond the threshold associated with the autonomous device may be carried out by transmitting to a service controller, a message requesting human intervention in stabilizing the stack.

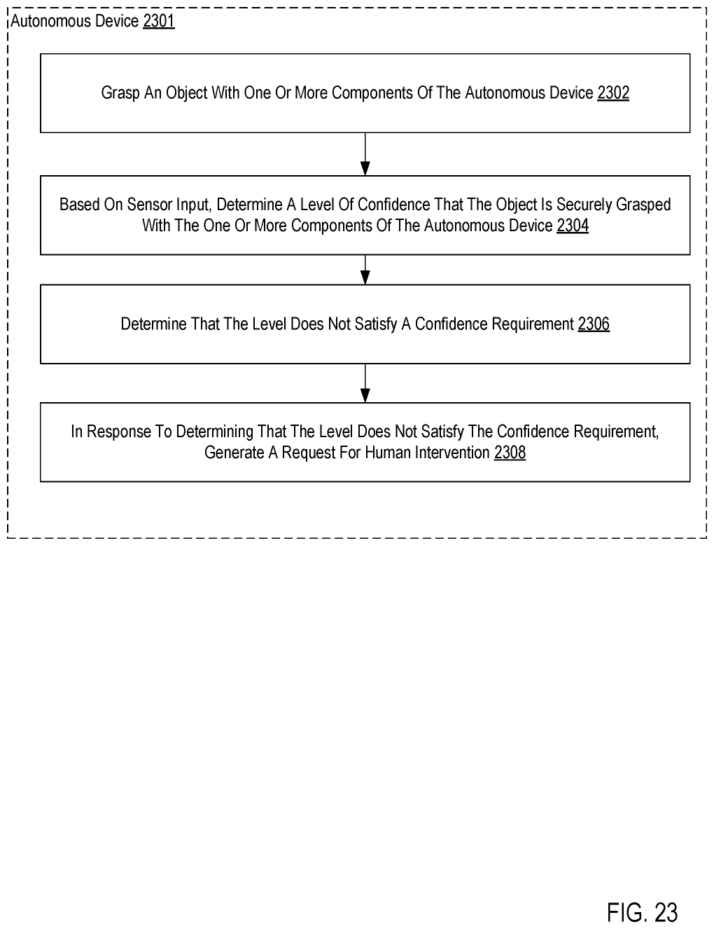

For further explanation, FIG. 23 sets forth a flow chart illustrating an exemplary method for enhancing autonomous operation in robotic devices with human intervention according to embodiments of the present disclosure. The method of FIG. 23 includes grasping 2302, by an autonomous device 2301, an object with one or more components of the autonomous device. Grasping 2302, by an autonomous device 2301, an object with one or more components of the autonomous device may be carried out by identify an object to move, determining how to grasp the object, and grasping the object using one or components of the autonomous device.

The method of FIG. 23 also includes based on sensor input, determining 2304, by the autonomous device 2301, a level of confidence that the object is securely grasped with the one or more components of the autonomous device 2301. Determining 2304 based on sensor input, by the autonomous device 2301, a level of confidence that the object is securely grasped with the one or more components of the autonomous device 2301 may be carried out by receiving sensor input (e.g., tactile sensors, pressure sensors, camera input, etc.) associated with the object and the components of the autonomous device; analyzing the sensor input; comparing the sensor input to historical records; and determining, based on the analysis of the sensor input, that the object is not securely grasped.

In addition, the method of FIG. 23 also includes determining 2306, by the autonomous device 2301, that the level does not satisfy a confidence requirement. Determining 2306, by the autonomous device 2301, that the level does not satisfy a confidence requirement may be carried out by determining based on the sensor input that the object has a particular probability of coming loose from the grasp of the autonomous device.

The method of FIG. 23 also includes in response to determining that the level does not satisfy the confidence requirement, generating 2308, by the autonomous device 2301, a request for human intervention. Generating 2308, by the autonomous device 2301, a request for human intervention in response to determining that the level does not satisfy the confidence requirement may be carried out by determining that the probability of the object coming loose exceeds a threshold associated with the confidence requirement.

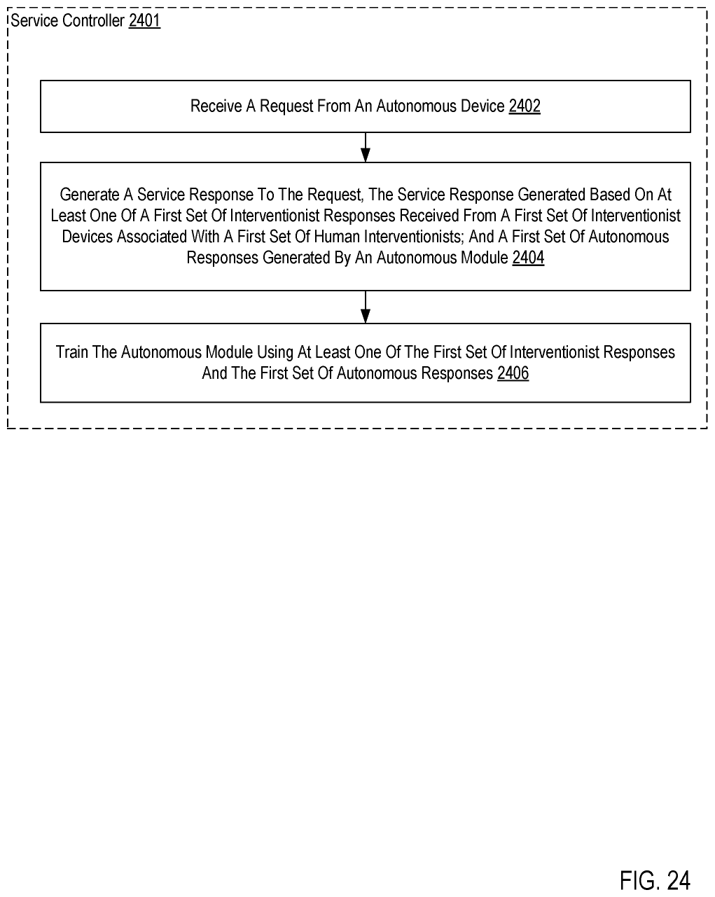

For further explanation, FIG. 24 sets forth a flow chart illustrating an exemplary method for enhancing autonomous operation in robotic devices with human intervention according to embodiments of the present disclosure. The method of FIG. 24 includes receiving 2402, by a service controller 2401, a request from an autonomous device. Receiving 2402, by a service controller 2401, a request from an autonomous device may be carried out by receiving via a wireless or wired connection, a message that specifies information regarding the autonomous device. Examples of the types of information that the request may include but are not limited to: an operational status of the autonomous device (e.g., on/off; stuck message; error message; alarm codes/messages; damaged equipment; etc.), an instruction/routine/process indication (e.g., right movement loop), a last step/operation/task/behavior performed (e.g., turned left; shutdown rotor), a plurality of decision choices (e.g., menu choices—identify objects as (a), (b), or (c)), a type of behavior/task that is required to perform (e.g., provide coordinates; guide robot movement), urgency indication (e.g. respond to five minutes), criteria for selecting a human interventionist (e.g., need a doctor; need a mechanic; need a level 8 technician; need lowest cost, available technician that can do level 7 operation on robot); and others as will occur to those of skill in the art after reading the subject disclosure.

The method of FIG. 24 also includes generating 2404, by the service controller 2401, a service response to the request, the service response generated based on least one of: a first set of interventionist responses received from a first set of interventionist devices associated with a first set of human interventionists; and a first set of autonomous responses generated by an autonomous module. In a particular embodiment, the service controller may have an autonomous module that is capable of generating a set of autonomous responses (e.g., one or more responses). The service controller may also send a request to one or more human interventionist devices and receive interventionist responses. Generating 2404, by the service controller 2401, a service response to the request, the service response generated based on least one of: a first set of interventionist responses received from a first set of interventionist devices associated with a first set of human interventionists; and a first set of autonomous responses generated by an autonomous module may be carried out by using one or more of the first set of autonomous responses and the first set of interventionist responses to create the service response, averaging the responses, and modifying the responses by reformatting, adding data, or removing data from the responses.

In addition, the method of FIG. 24 also includes training 2406, by the service controller 2401, the autonomous module using at least one of the first set of interventionist responses and the first set of autonomous responses. Training 2406, by the service controller 2401, the autonomous module using at least one of the first set of interventionist responses and the first set of autonomous responses may be carried out by determining the most common response among the responses (autonomous responses and interventionist responses); using the determined most common response as the response that the autonomous module should provide in response to receiving a similar request. In a particular embodiment, the service controller may determine the outcome of the service response to determine whether the service response is used as the response that the autonomous module should provide in response to receiving a similar response. In another embodiment, the service controller may utilize feedback from the autonomous device to determine whether the service response is used as the response that the autonomous module should provide in response to receiving a similar response.

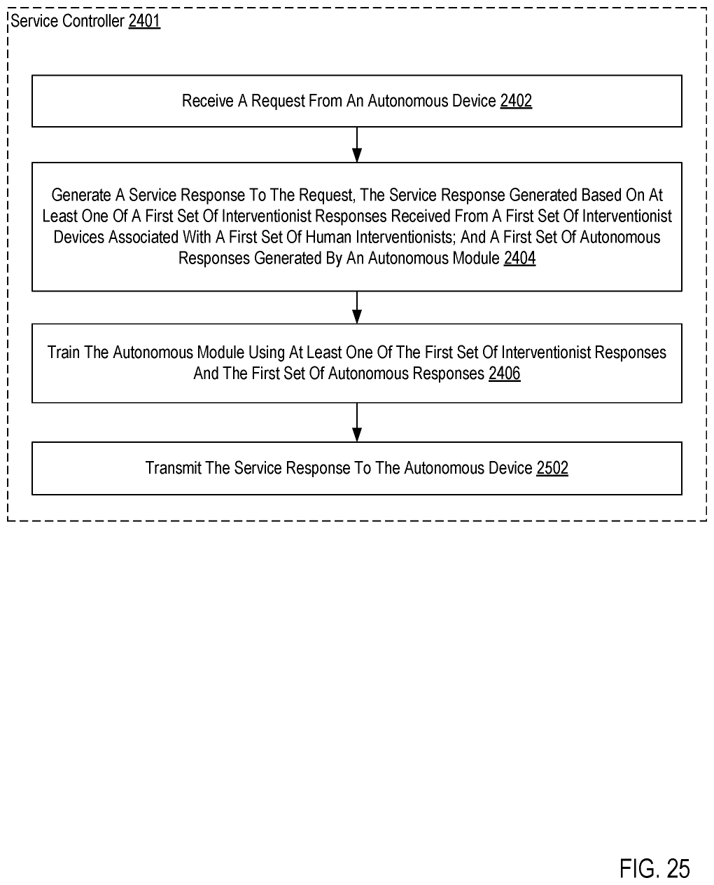

For further explanation, FIG. 25 sets forth a flow chart illustrating an exemplary method for enhancing autonomous operation in robotic devices with human intervention according to embodiments of the present disclosure. The method of FIG. 25 is similar to the method of FIG. 24 in that the method of FIG. 25 also includes receiving 2402, by a service controller 2401, a request from an autonomous device; generating 2404, by the service controller 2401, a service response to the request, the service response generated based on least one of: a first set of interventionist responses received from a first set of interventionist devices associated with a first set of human interventionists; and a first set of autonomous responses generated by an autonomous module; and training 2406, by the service controller 2401, the autonomous module using at least one of the first set of interventionist responses and the first set of autonomous responses.

However, unlike the method of FIG. 24, the method of FIG. 25 includes transmitting 2502, by the service controller 2401, the service response to the autonomous device. Transmitting 2502, by the service controller 2401, the service response to the autonomous device may be carried out by sending the response via a wireless or wired communication network or connection to the autonomous device.

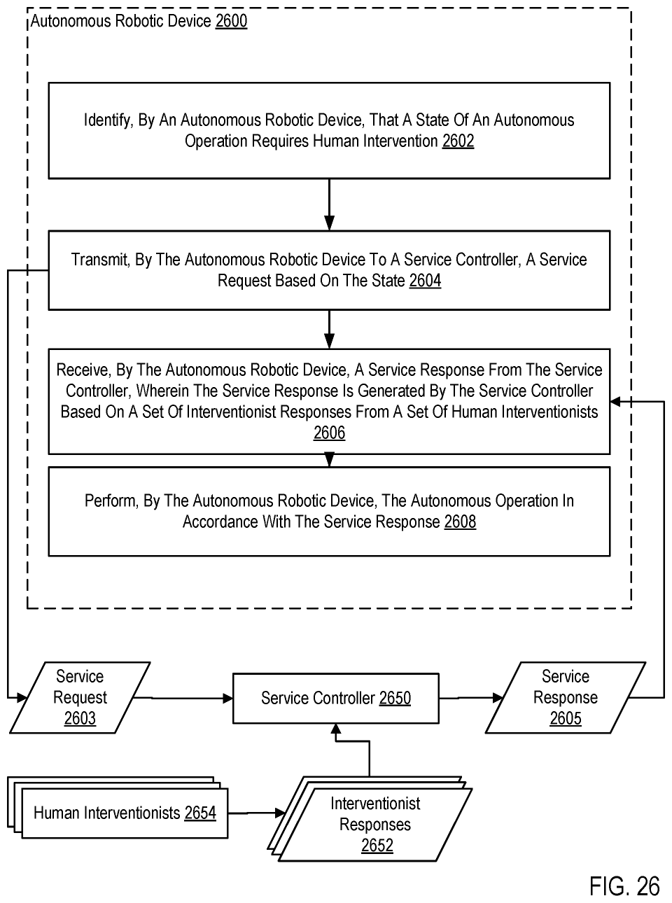

For further explanation, FIG. 26 sets forth a flow chart illustrating an exemplary method for enhancing autonomous operation in robotic devices with human intervention in accordance with at least one embodiment of the present disclosure. The example of FIG. 26 includes an autonomous robotic device 2600. The autonomous robotic device 2600 may be similar to any of the autonomous devices described above, such as autonomous device 111 of FIG. 1. The autonomous robotic device 2600 may include the same or fewer components as the autonomous device 111, as well as additional components. The autonomous robotic device 2600 is configured to carry out one or more autonomous operations based on routines, processes, and instructions executed by the autonomous robotic device 2600. As discussed above, an autonomous operation may be a task (e.g., grasp object A), a series of tasks (grasp object A and place in container B), or a routine (for each object in container C, locate an object, grasp the object, and place in container D) that the autonomous robotic device 2600 is configured to carry out without human control or assistance. Examples of types of tasks to be performed autonomously may include but are not limited to identifying an object to select; identifying a location; relocating an object; identifying a label for an object or action; selecting from a plurality of choices; identifying a route; navigating to a location; identifying a next task to perform; determining that a task has been performed successfully; and so on. Although the autonomous robotic device 2600 is configured to perform such tasks autonomously, conditions may arise in which human support is needed to carry out the operation.

The method of FIG. 26 includes identifying 2602, by an autonomous robotic device 2600, that a state of an autonomous operation requires human intervention. The autonomous robotic device 2600 may identify a state that requires human intervention at the planning, execution, or completion stages of an autonomous operation. For example, during a planning phase, the autonomous robotic device 2600 may need assistance in determining the next task, identifying an object to select, identifying a route, and so on. During an execution phase, the autonomous robotic device 2600 may need assistance, for example, locating a placement for an object, navigating around an obstacle, correcting for an unexpected condition, and so on. Upon completing a task, the autonomous robotic device 2600 may need assistance in determining that the task was completed successfully, that the outcome is safe, and so on. In assessing the state of the autonomous operation, the autonomous robotic device 2600 may utilize a variety of on-board sensors, such as vision cameras, infrared sensors, radar, lidar, speed sensors, accelerometers, gyroscopes, force sensors, and so on. In identifying that human intervention is required, the autonomous robotic device 2600 may determine, for example, that the state of the operation is that the autonomous robotic device 2600 is physically incapable of performing the task (e.g., the device is stuck or cannot maneuver), the autonomous robotic device 2600 is logically incapable of performing the task (e.g., the device cannot distinguish between two objects), or that the autonomous robotic device 2600 cannot complete the task with a satisfactory confidence level or safety measure.

To aid illustration, an example of a state that may require human intervention may be an autonomous device traveling along a path and encountering an obstacle that interrupts the autonomous operation of the autonomous device. Another example may include a drone being unable to locate a safe place to land. Yet another example may be a pick and place robot being unable to distinguish between an apple and a pear. A still further example may be a stacking robot being unable to confidently determine where to stack the next object without causing instability in the stack.

In some examples, a state of an autonomous operation that requires human intervention may include a task that is outside of the operational design domain of the autonomous robotic device 2600. The operation design domain may limit operation of the autonomous robotic device 2600 where human safety is a factor. For example, a drone may be configured to autonomously land at a landing site where no humans are present. However, a drone landing at a landing site where humans are present may be outside of the operational design domain. Thus, in this example, when the state of the autonomous landing operation includes the presence of humans near the drone destination, completion of the landing may require human intervention to select the safest landing site.

The method of FIG. 26 also includes transmitting 2604, by the autonomous robotic device 2600 to a service controller 2650, a service request 2603 based on the state of the autonomous operation. The service controller 2650 may be similar to any of the service controllers discussed above. In some examples, transmitting 2604, by the autonomous robotic device 2600 to a service controller 2650, a service request 2603 based on the state of the autonomous operation is carried out by transmitting a message describing the state of the autonomous operation and identifying a task or condition for which assistance is required. In some examples, upon identifying a state of the autonomous operation that requires human intervention, the autonomous robotic device 2600 may halt the autonomous operation and generate a service request based on the identified state. The service request 2603 provides information related to the state of the autonomous operation that is useful to a set of human interventionists for providing assistance to the autonomous robotic device 2600, as discussed above. Examples of the types of this information in the service request 2603 may include but are not limited to: an operational status of the autonomous robotic device 2600 (e.g., on/off; stuck message; error message; alarm codes/messages; damaged equipment; etc.); an instruction/routine/process indication (e.g., right movement loop); a last step, operation, task or behavior performed (e.g., turned left; shutdown rotor); a plurality of decision choices (e.g., menu choices—identify objects as (a), (b), or (c)); a type of behavior/task that is requested (e.g., provide coordinates; guide robot movement); urgency indication (e.g. respond to five minutes); criteria for selecting a human interventionist (e.g., need a doctor; need a mechanic; need a level 8 technician; need lowest cost, available technician that can do level 7 operation on robot); and others as will occur to those of skill in the art in view the present disclosure. The service request 2603 may be transmitted by the autonomous robotic device 2600 to the service controller 2650 as a message through an API, electronic message (e.g., SMS text or email), or some other electronic medium using a wired or wireless communications channel between the service controller 2650 and the autonomous robotic device 2600.

The method of FIG. 26 also includes receiving 2606, by the autonomous robotic device 2600, a service response 2605 from the service controller 2650, wherein the service response 2605 is generated by the service controller 2650 based on a set of interventionist responses 2652 from a set of human interventionists 2654 (through respective interventionist devices). As discussed above, upon receiving a service request 2603, the service controller sends a request for human intervention to a set of human interventionists. The request to the human interventionists may also include information provided in the service request 2603 as well as additional information. Each human interventionist receives the request and provides a response. The response may include assistance information to enable the autonomous robotic device 2600 to resolve the state of the autonomous operation that requires human intervention. For example, the human interventionist response may provide a solution to overcome an obstacle to impeding the completion of a task, such as coordinates for traveling around an obstacle in the path of the autonomous robotic device 2600. The service controller 2650 processes the interventionist responses 2652 using a variety of techniques, as discussed above. For example, the service controller 2650 may average the interventionist responses 2652, select a solution provided in the interventionist responses 2652 that has the most agreement among human interventionists 2654, calculate a confidence score for a particular solution, solicit additional interventionist responses from a different set of human interventionists, and so on. The service controller 2650 generates the service response 2605 by formatting information describing the solution to the state of the autonomous operation as data that is understood by the autonomous robotic device 2600. For example, the service response 2605 is embodied in a message that is provided to the autonomous robotic device 2600 through any the communication protocols described above. Thus, none of the human interventionists 2654 exerts any direct control over the autonomous robotic device 2600. Moreover, while the service controller 2650 controls communication with the human interventionists and generating data for a service response 2605, the service controller 2650 does not exert any direct control over the autonomous robotic device 2600.

The method of FIG. 26 also includes performing 2608, by the autonomous robotic device 2600, the autonomous operation in accordance with the service response 2605. The service response 2605 includes data and other information that enables the autonomous robotic device 2600 to resolve the impediment to completing a task, or advance the state of the autonomous operation, autonomously and without a human exercising any direct real-time control of the autonomous robotic device 2600. For example, to navigate around an obstacle, the service response 2605 may include a motion plan, a series of coordinates, or some other data that modifies the navigation routine of the autonomous robotic device 2600. As another example, to land a drone in consideration of human safety measures, the service response 2605 may include landing coordinates at the landing site, modifications to drone speed or operation, a set of waypoints to navigate to a new landing site, and so on. As yet another example, to complete a stacking task, the service response 2605 may include a location for stacking an object, a plan for rearranging the stack to increase stability, an ordering of objects for stacking, and so on. As yet another example, to complete an object selection and grasping task, the service response 2605 may include an identification of a particular object among other objects, a force to apply in grasping the object, and so on.

Thus, the autonomous robotic device 2600 uses the information in the 2605 to make modifications to its operation, routine, or motion plan to autonomously remove an impediment to a task, complete a task, improve the outcome of the task, or otherwise resolve or advance the state of the autonomous operation. The service response includes high level support that enables the autonomous robotic device to complete the autonomous task independent of any control of the autonomous robotic device 2600 by the service controller 2650 or a human interventionist. The high-level support does not include control of the robotic device or a stream of data that controls the articulation or movement of individual actuators of the autonomous robotic device 2600. For example, the high-level support does not include joystick teleoperation of a robotic device or instructions to adjust individual servomotors, wheel or propeller speeds, rutter angles, etc. Rather, the high-level support may be, for example, a suggested course of action or assistance in resolving a perception dilemma. Thus, autonomous operations are performed based on intermittent messaging between the autonomous robotic device 2600 and the service controller 2650 in the form of discrete service requests and discrete service responses. As such, there is no continuous stream of messaging or data to directed to the autonomous robotic device 2600 to perform the operation.

In some examples, the autonomous robotic device 2600 identifies a plan suggested by the high-level support provided in the service response 2605. Illustrative examples include executing a sequence of movements suggested in the service response 2605 to complete a task, selecting a next task based on the service response 2605, following navigation route suggested in the service response 2605, or placing an object at a particular coordinate suggested in the service response 2605, to name a few. However, in other examples, the autonomous robotic device 2600 uses information provided by the high-level support in the service response 2605 to generate its own plan to overcome the hindrance to the task. Illustrative examples include the autonomous robotic device 2600 generating a new navigation route based on information in the service response 2605, using information in the service response 2605 for one task to distinguish and choose objects in subsequent tasks, generating a new stacking plan using information about the current state of the stack identified in the service response 2605, to name a few

In the above examples, it should be apparent that the service response 2605 does not provide human control over the autonomous robotic device 2600. Rather, the autonomous robotic device 2600 uses the information in the service response 2605 to perform a task autonomously. In fact, in some cases, the autonomous robotic device 2600 may decline to follow a recommended course of action identified in the service response 2605. For example, the autonomous robotic device 2600 may determine that, even using the information in the service response 2605, the autonomous robotic device 2600 cannot complete a task. In such cases, the autonomous robotic device 2600 may, for example, generate a new service request, abort the autonomous operation or task, or return an error code to the service controller 2650.

As stated above, upon requesting human intervention in relation to completing a task, the autonomous robotic device 2600 uses the service response 2605 to complete the task independent of any control of the autonomous robotic device 2600 by the service controller 2650 or a human interventionist. Further, the autonomous robotic device 2600 does not leave an autonomous operation mode to complete the task. Any autonomous device includes finite state machine logic, artificial intelligence, or some other underlying program logic that configures the device to carry out operations in an autonomous mode. Conventionally, human intervention to complete a task requires discontinuing the autonomous mode of operation in favor of a human operation mode such as teleoperation. In accordance with the present disclosure, the autonomous robotic device 2600 remains in the autonomous operation mode while generating the service request, receiving the service response, and performing the operation autonomously based on the service response. The high-level support provided in the service response provides the autonomous robotic device 2600 with sufficient information to resolve the dilemma encountered by the underlying program logic, thus allowing the autonomous robotic device 2600 to transition to the next state. Further, the autonomous robotic device 2600 does not discontinue a perception loop associated with the autonomous mode of operation. That is, when performing the autonomous operation in accordance with the service response 2605, the autonomous robotic device 2600 continues to receive GPS data, camera data, tactile sensor data, and other environmental sensors to aid the autonomous robotic device 2600 in performing the autonomous operation in accordance with the service response 2605.

In view of the foregoing aspects, it will be apparent that performing 2608, by the autonomous robotic device 2600, the autonomous operation in accordance with the service response 2605 is markedly different from human intervention through teleoperation of an autonomous device and from a teleoperation mode. For example, teleoperation requires continuous communication between the remote controller device and the autonomous device (e.g., a constant stream of joystick coordinates). By contrast, the autonomous robotic device 2600 receives assistance intermittently in the form of a discrete service response 2605. A robotic device operating in a teleoperation mode has discontinued its autonomous operation mode and thus does not utilize the finite state machine logic, artificial intelligence, or other underlying program logic to perform the operation. By contrast, the autonomous robotic device 2600 continues the autonomous operation mode and compliments its underlying program logic with human support. A robotic device operating in a teleoperation mode does not require a perception loop that continually senses the environment. By contrast, the autonomous robotic device 2600 uses the support provided in the service response 2605 in conjunction with its own perception to complete the task autonomously.

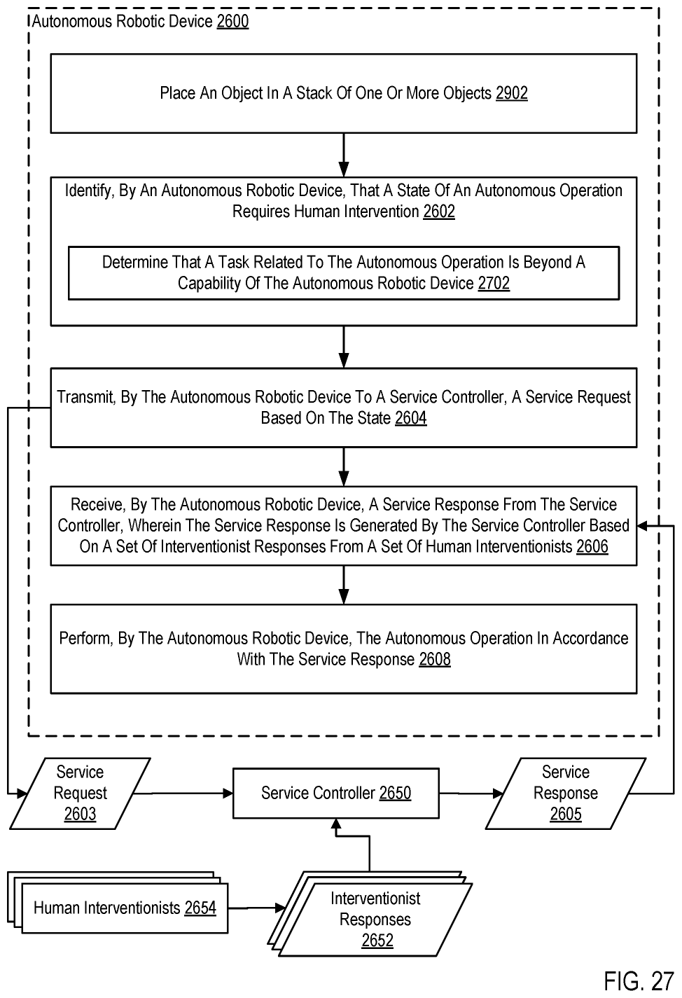

For further explanation, FIG. 27 sets forth a flow chart illustrating an exemplary method for enhancing autonomous operation in robotic devices with human intervention in accordance with at least one embodiment of the present disclosure. The example method in FIG. 27 is similar to the example method in FIG. 26 in that the example method of FIG. 27 also includes identifying 2602, by an autonomous robotic device 2600, that a state of an autonomous operation requires human intervention; transmitting 2604, by the autonomous robotic device to a service controller 2650, a service request 2603 based on the state; receiving 2606, by the autonomous robotic device 2600, a service response 2605 from the service controller, wherein the service response is generated by the service controller based on a set of interventionist responses 2652 from a set of human interventionists 2654; and performing 2608, by the autonomous robotic device 2600, the autonomous operation in accordance with the service response 2605.

In the example of FIG. 27, identifying 2602, by an autonomous robotic device 2600, that a state of an autonomous operation requires human intervention includes determining 2702 that a task related to the autonomous operation is beyond a capability of the autonomous robotic device 2600. In some examples, the autonomous robotic device 2600 determines that a task is beyond the capability of the autonomous robotic device 2600 by attempting to perform a task and failing to complete the task. For example, the autonomous robotic device 2600 may attempt and fail to navigate around an obstacle. The autonomous robotic device 2600 may utilize a threshold number of attempts or a threshold amount of time to determine that the task is beyond the capability of the autonomous robotic device 2600. Determining that a task is beyond a level of capability may also be determined based on a list of task types, modalities, or other situations that are predetermined to require human intervention.

In other examples, the autonomous robotic device 2600 determines 2702 that a task is beyond the capability of the autonomous robotic device 2600 by determining that the autonomous robotic device 2600 has insufficient information to attempt or perform the task. For example, the autonomous robotic device 2600 may be unable to distinguish object type A from object type B based on the properties and characteristics of those objects. A library of object properties and characteristics may be programmed in or learned by (e.g., via a machine learning model) the autonomous robotic device 2600 and stored in a memory.

In some examples, the autonomous robotic device 2600 determines 2702 that a task is beyond the capability of the autonomous robotic device 2600 by determining that performance of the task is outside of the operational design domain of the autonomous robotic device 2600. In some examples, the operational design domain is based at least on human safety requirements. Thus, the autonomous robotic device 2600 may determine that it is incapable of performing the task in accordance with human safety requirements. For example, the autonomous robotic device 2600 may determine the completion of the task (e.g., landing a drone) in the presence of humans is outside the operational design domain.

In some examples, the autonomous robotic device 2600 determines 2702 that the autonomous operation is beyond the capability of the autonomous robotic device 2600 if it is unable to determine a next task to perform the autonomous operation. For example, after completing a task to stack an object onto a stack of objects, the autonomous robotic device 2600 may be unable to determine which object to stack next. In some cases, such a determination may be based on a confidence level in choosing the next object to stack or where to place the object, which is discussed in more detail below.

In some examples, the autonomous robotic device 2600 determines 2702 that the autonomous operation is beyond the capability of the autonomous robotic device 2600 based on a determination that the autonomous robotic device 2600 cannot identify that the task was successfully completed. In such examples, the autonomous robotic device 2600 may utilize sensor information to assess the completion of the task. If the autonomous robotic device 2600 is unable to determine that the outcome is accordance with an intended or required outcome, the autonomous robotic device 2600 may determine that it cannot determine that the task was successfully completed. In other examples, the autonomous robotic device 2600 may be able to determine the success of the outcome but determines that the task was unsuccessfully completed. In some examples, determining the success of the task may be based on determining that the outcome is within a margin of error or determining a probability that the task was successfully completed.

In some examples, determines 2702 that the autonomous operation is beyond the capability of the autonomous robotic device 2600 by analyzing a historical record to determine whether the task has successfully been performed by the autonomous device. In such examples, the autonomous device may determine that the autonomous device has previously attempted unsuccessfully to perform the task or has previously performed the task successfully. For example, the autonomous robotic device 2600 may determine that it has previously failed to navigate around a particular obstacle.

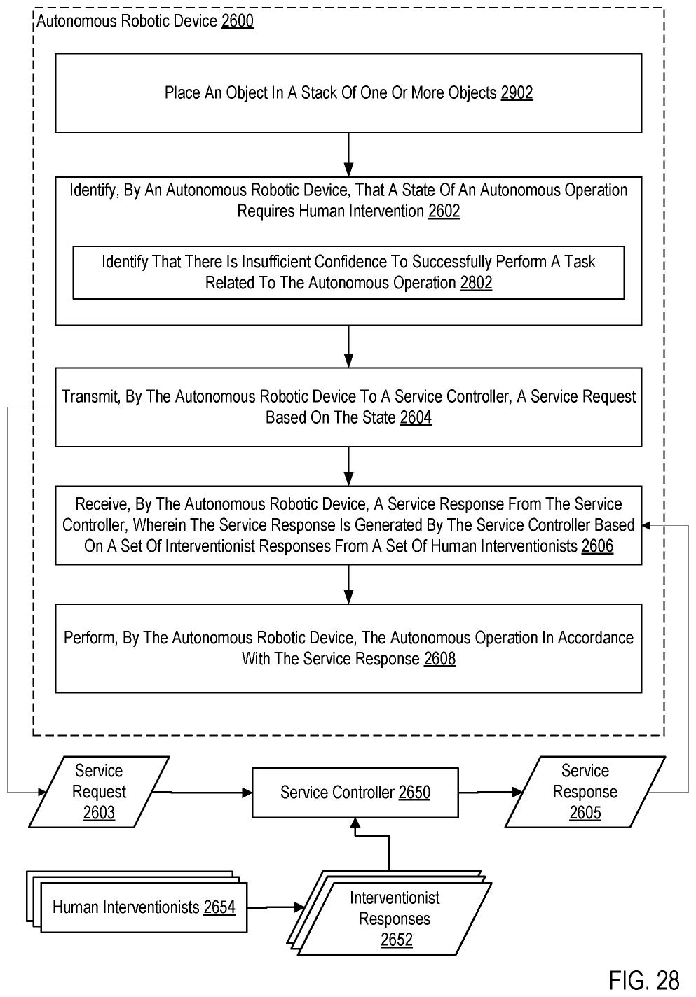

For further explanation, FIG. 28 sets forth a flow chart illustrating an exemplary method for enhancing autonomous operation in robotic devices with human intervention in accordance with at least one embodiment of the present disclosure. The example method in FIG. 28 is similar to the example method in FIG. 26 in that the example method of FIG. 28 also includes identifying 2602, by an autonomous robotic device 2600, that a state of an autonomous operation requires human intervention; transmitting 2604, by the autonomous robotic device to a service controller 2650, a service request 2603 based on the state; receiving 2606, by the autonomous robotic device 2600, a service response 2605 from the service controller, wherein the service response is generated by the service controller based on a set of interventionist responses 2652 from a set of human interventionists 2654; and performing 2608, by the autonomous robotic device 2600, the autonomous operation in accordance with the service response 2605.

In the example of FIG. 28, identifying 2602, by an autonomous robotic device 2600, that a state of an autonomous operation requires human intervention includes identifying 2802 that there is insufficient confidence to successfully perform a task related to the autonomous operation. In some examples, autonomous robotic device 2600 identifies 2802 that there is insufficient confidence to successfully perform a task related to the autonomous operation by determining a confidence score for the task, where the confidence score represents a level of confidence that the autonomous robotic device 2600 can perform the task successfully. In such examples, if the confidence score is below a threshold score, the autonomous robotic device 2600 determines that there is insufficient confidence to perform the task successfully. In some variations, the confidence score is based on a historical record of performing the task. For example, the autonomous robotic device 2600 may identify from a historical record that the autonomous robotic device 2600 has successfully place an object at a destination only two of the last five attempts. In some variations, the confidence score is based on an error probability, where the error probability represents the probability that the autonomous robotic device 2600 may not perform the task successfully. For example, if the autonomous robotic device 2600 determines that there is a 20% chance that a drone will unsuccessfully land at a landing site due to weather conditions, terrain, etc., the autonomous robotic device 2600 may factor this error probability into a confidence score (which may result in the confidence score being below a threshold score).

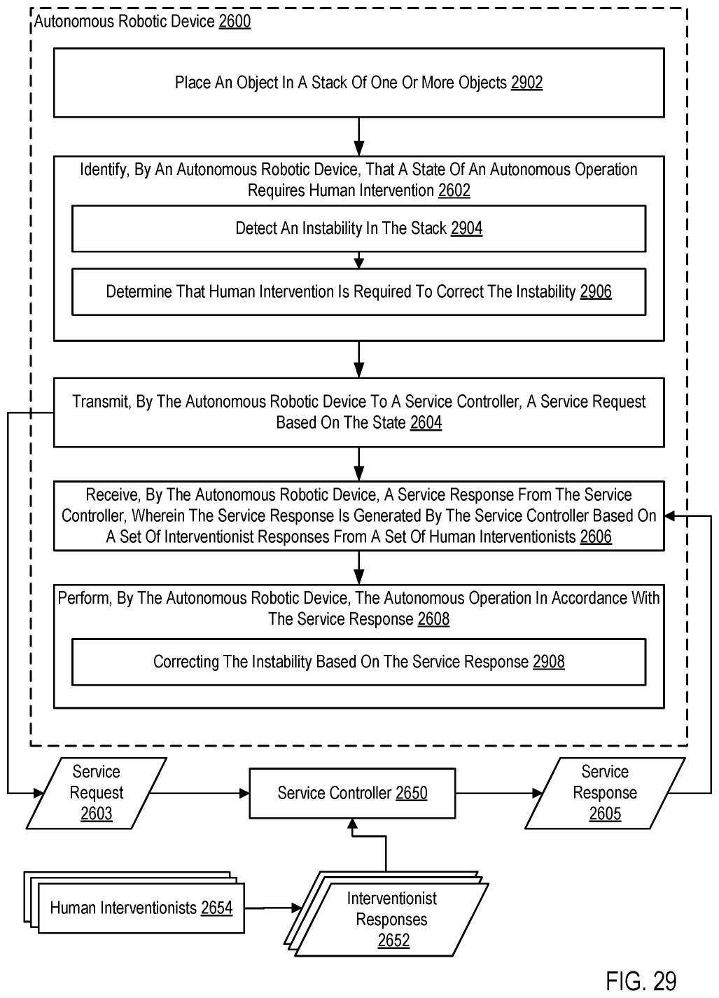

For further explanation, FIG. 29 sets forth a flow chart illustrating an exemplary method for enhancing autonomous operation in robotic devices with human intervention in accordance with at least one embodiment of the present disclosure. The example method in FIG. 29 is similar to the example method in FIG. 26 in that the example method of FIG. 29 also includes identifying 2602, by an autonomous robotic device 2600, that a state of an autonomous operation requires human intervention; transmitting 2604, by the autonomous robotic device to a service controller 2650, a service request 2603 based on the state; receiving 2606, by the autonomous robotic device 2600, a service response 2605 from the service controller, wherein the service response is generated by the service controller based on a set of interventionist responses 2652 from a set of human interventionists 2654; and performing 2608, by the autonomous robotic device 2600, the autonomous operation in accordance with the service response 2605.

The method of FIG. 29 also includes placing 2902 an object on a stack of one or more objects. In some examples, the autonomous robotic device 2600 places 2902 an object in a stack of one or more objects by using an autonomous process to identify an object to move, determining how to grasp the object, grasping the object using one or components of the autonomous device, identifying a location to place the object, moving the object to the location, and releasing the object.

In the method of FIG. 29, identifying 2602, by an autonomous robotic device 2600, that a state of an autonomous operation requires human intervention includes detecting 2904 an instability in the stack. In some examples, the autonomous robotic device 2600 detects 2904 instability in the stack in response to placing the object in the stack by receiving sensor input associated with the object; analyzing the sensor input; comparing the sensor input to historical records, and determining, based on the analysis of the sensor input, that the object or stack is unstable. For example, the autonomous device may determine from pictures of the stack that one or more objects in the stack forms a configuration that historically has shown to be unstable.

In the method of FIG. 29, identifying 2602, by an autonomous robotic device 2600, that a state of an autonomous operation requires human intervention also includes determining 2906 that human intervention is required to correct the instability. In some examples, the autonomous robotic device 2600 determines that human intervention is required to correct the instability by analyzing a historical record to determine whether the identified unstable configuration has successfully been stabilized by the autonomous device. For example, the autonomous device may determine that the autonomous device has previously attempted unsuccessfully to stabilize this type of stacked configuration.

In the method of FIG. 29, performing 2608, by the autonomous robotic device 2600, the autonomous operation in accordance with the service response 2605 includes correcting 2908 the instability based on the service response 2605. In some examples, autonomous robotic device 2600 receives a service response 2605 that includes information describing a process to correct the instability. For example, the service response 2605 may include instructions for rearranging objects to correct the instability. The autonomous robotic device 2600 completes the movements, in accordance with the instructions, to rearrange the stack to correct the instability. In such examples, the autonomous robotic device 2600 corrects the instability autonomously, independent of any human controller, and without any further information from the service controller 2650 or human interventionist.

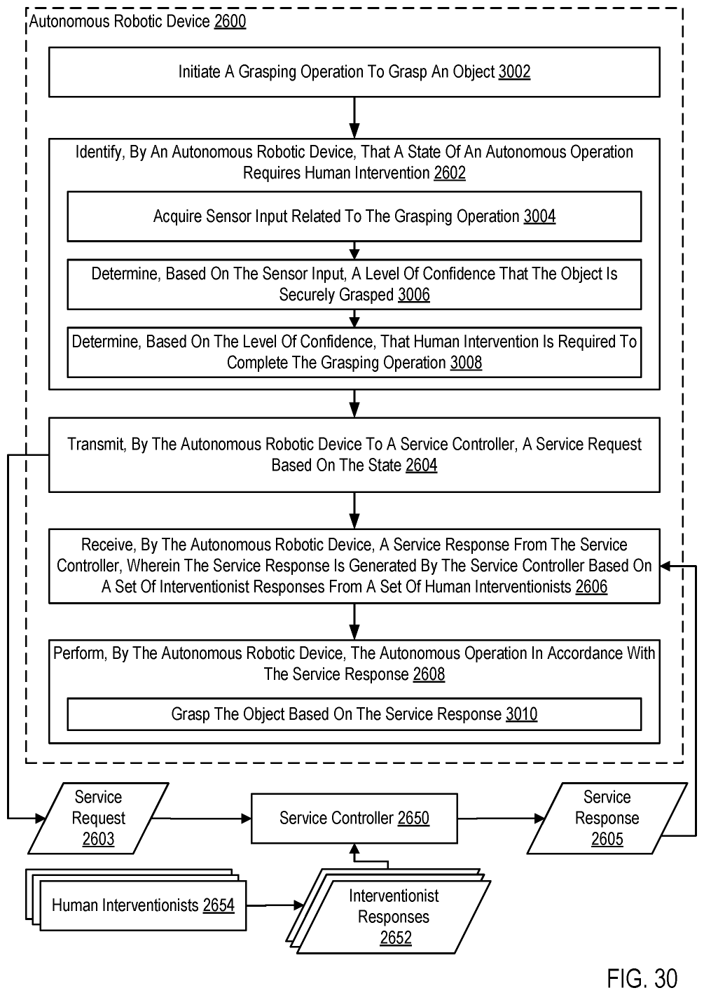

For further explanation, FIG. 30 sets forth a flow chart illustrating an exemplary method for enhancing autonomous operation in robotic devices with human intervention in accordance with at least one embodiment of the present disclosure. The example method in FIG. 30 is similar to the example method in FIG. 26 in that the example method of FIG. 30 also includes identifying 2602, by an autonomous robotic device 2600, that a state of an autonomous operation requires human intervention; transmitting 2604, by the autonomous robotic device to a service controller 2650, a service request 2603 based on the state; receiving 2606, by the autonomous robotic device 2600, a service response 2605 from the service controller, wherein the service response is generated by the service controller based on a set of interventionist responses 2652 from a set of human interventionists 2654; and performing 2608, by the autonomous robotic device 2600, the autonomous operation in accordance with the service response 2605.

The method of FIG. 30 also includes initiating 3002 a grasping operation to grasp an object. In some examples, the autonomous robotic device 2600 initiates a grasping of an object using one or more components of the autonomous device. For examples, the autonomous robotic device 2600 may identify an object to move, determine how to grasp the object, and grasp the object using one or components of the autonomous device.

In the method of FIG. 30, identifying 2602, by an autonomous robotic device 2600, that a state of an autonomous operation requires human intervention includes acquiring 3004 sensor input related to the grasping operation. In some examples, the autonomous robotic device 2600 receives sensor input (e.g., tactile sensors, pressure sensors, camera input, etc.) associated with the object and the components of the autonomous device.

In the method of FIG. 30, identifying 2602, by an autonomous robotic device 2600, that a state of an autonomous operation requires human intervention includes determining 3006, based on the sensor input, a level of confidence that the object is securely grasped. In some examples, the autonomous robotic device 2600 analyzes the sensor input, compares the sensor input to historical records, and determines, based on the analysis of the sensor input, a confidence score indicating a confidence that the object is securely grasped. In some examples, the autonomous robotic device 2600 may determines, based on the confidence score, that the object has a particular probability of coming loose from the grasp of the autonomous device.

In the method of FIG. 30, identifying 2602, by an autonomous robotic device 2600, that a state of an autonomous operation requires human intervention includes determining 3008, based on the level of confidence, that human intervention is required to complete the grasping operation. In some examples, the autonomous robotic device 2600 determines 3008 that human intervention is required by determining that the confidence level does not satisfy the confidence requirement. For example, the autonomous robotic device 2600 may determine that the probability of the object coming loose exceeds a threshold associated with the confidence requirement.

In the method of FIG. 30, performing 2608, by the autonomous robotic device 2600, the autonomous operation in accordance with the service response 2605 includes grasping 3010 the object based on the service response. In some examples, autonomous robotic device 2600 receives a service response 2605 includes information describing parameters or a process for grasping the object. For example, the service response 2605 may include instructions for an amount of force to apply, a location where the object should be grasped, an approach angle for grasping the object, etc. The autonomous robotic device 2600 grasps the object in accordance with those instructions and parameters. In such examples, the autonomous robotic device 2600 grasps the object autonomously, independent of any human controller, and without any further information from the service controller 2650 or human interventionist.

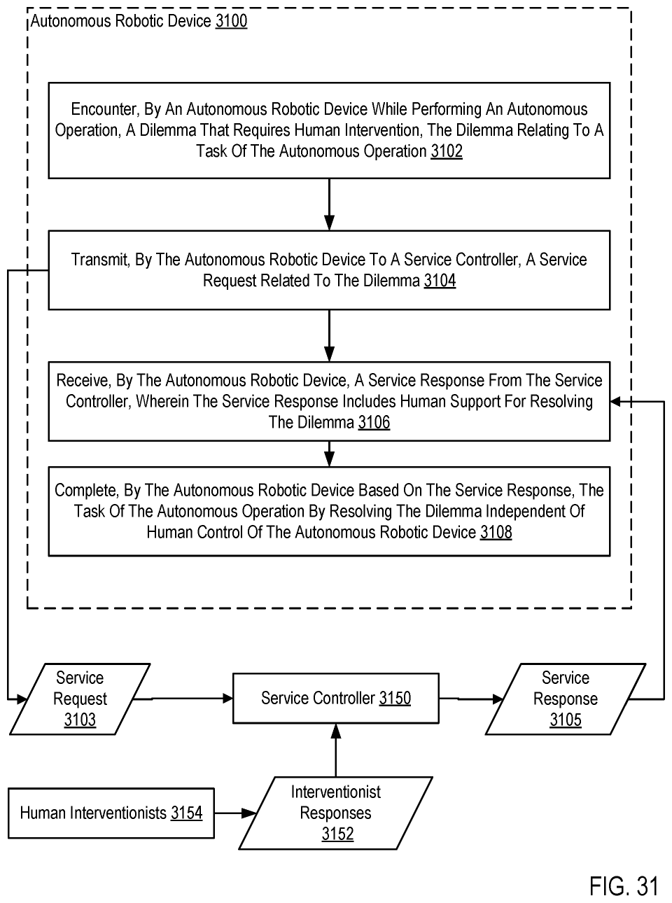

For further explanation, FIG. 31 sets forth a flow chart illustrating an exemplary method for enhancing autonomous operation in robotic devices with human intervention in accordance with at least one embodiment of the present disclosure. The example of FIG. 31 includes an autonomous robotic device 3100, which may be similar to the autonomous robotic device 2600 and any other autonomous device described above. The method of FIG. 31 includes encountering 3102, by an autonomous robotic device 3100 while performing an autonomous operation, a dilemma that requires human intervention, the dilemma relating to a task of the autonomous operation. The autonomous robotic device 3100 may identify a dilemma that requires human intervention at the planning, execution, or completion stages of an autonomous operation. For example, during a planning phase, the autonomous robotic device 3100 may need assistance in determining the next task, identifying an object to select, identifying a route, and so on. During an execution phase, the autonomous robotic device 3100 may need assistance, for example, locating a placement for an object, navigating around an obstacle, correcting for an unexpected condition, and so on. Upon completing a task, the autonomous robotic device 3100 may need assistance in determining that the task was completed successfully, that the outcome is safe, and so on. In assessing the need for human intervention, the autonomous robotic device 2600 may utilize a variety of on-board sensors, such as vision cameras, infrared sensors, radar, lidar, speed sensors, accelerometers, gyroscopes, force sensors, and so on. In identifying that human intervention is required, the autonomous robotic device 2600 may determine, for example, that the autonomous robotic device 2600 is physically incapable of performing the task (e.g., the device is stuck or cannot maneuver), the autonomous robotic device 2600 is logically incapable of performing the task (e.g., the device cannot distinguish between two objects), or that the autonomous robotic device 2600 cannot complete the task with a satisfactory confidence level or safety measure.

The method of FIG. 31 also includes transmitting 3104, by the autonomous robotic device 3100 to a service controller 3150, a service request 3103 related to the dilemma. Transmitting 3104 a service request 3103 may be carried out described above. The service request 2603 provides information related to the state of the autonomous operation that is useful to a set of human interventionists to provide support enabling the autonomous robotic device 3100 to resolve the dilemma related to the task.

The method of FIG. 31 also includes receiving 3106, by the autonomous robotic device 3100, a service response 3105 from the service controller 3150, wherein the service response 3105 includes human support for resolving the dilemma. In some examples, the autonomous robotic device 3100 receives the service response 3105 as a message from the service controller 3150. After a human interventionist 3154 has reviewed data related to the dilemma and the task, the human provides information in an interventionist response 3152 to support resolution of the dilemma to the service controller 3150, which formats the information and sends the information in the form of a service response 3105 to the autonomous robotic device 3100. The human-provided support is high level support that enables the autonomous robotic device to complete the autonomous task independent of any control of the autonomous robotic device 3100 by the service controller 3150 or a human interventionist. That is, the high-level support does not include control of the robotic device or a stream of data that controls the articulation or movement of individual actuators of the autonomous robotic device 3100. For example, the high-level support does not include joystick teleoperation of a robotic device or instructions to adjust individual servomotors, wheel or propeller speeds, rutter angles, etc. Rather, the high-level support may be, for example, a suggested course of action to resolve the dilemma or assistance in resolving a perception dilemma. Thus, autonomous operations are performed based on intermittent messaging between the autonomous robotic device 3100 and the service controller 3150 in the form of discrete service requests and discrete service responses. As such, there is no continuous intervention or continuous stream of messaging or data to directed to the autonomous robotic device 3100 to perform the operation.

The method of FIG. 31 also includes completing 3108, by the autonomous robotic device 3100 based on the service response 3105, the task of the autonomous operation by resolving the dilemma independent of human control of the autonomous robotic device. The service response 3105 includes data and other information that enables the autonomous robotic device 3100 to resolve the impediment to completing a task, or advance the state of the autonomous operation, autonomously and without a human exercising any direct real-time control of the autonomous robotic device 3100. For example, to navigate around an obstacle, the service response 3105 may include a motion plan, a series of coordinates, or some other data that modifies the navigation routine of the autonomous robotic device 3100. As another example, to land a drone in consideration of human safety measures, the service response 3105 may include landing coordinates at the landing site, modifications to drone speed or operation, a set of waypoints to navigate to a new landing site, and so on. As yet another example, to complete a stacking task, the service response 3105 may include a location for stacking an object, a plan for rearranging the stack to increase stability, an ordering of objects for stacking, and so on. As yet another example, to complete an object selection and grasping task, the service response 3105 may include an identification of a particular object among other objects, a force to apply in grasping the object, and so on. The autonomous robotic device 3100 completes 3208 the task by using the support in the 2605 to supplement its underlying program logic or finite state machine logic to autonomously remove an impediment to a task, complete a task, improve the outcome of the task, or otherwise resolve the dilemma related to the task of the autonomous operation.

In some examples, the autonomous robotic device 3100 identifies a plan suggested by the high-level support provided in the service response 3105. Illustrative examples include executing a sequence of movements suggested in the service response 3105 to complete a task, selecting a next task based on the service response 3105, following navigation route suggested in the service response 3105, or placing an object at a particular coordinate suggested in the service response 3105, to name a few. However, in other examples, the autonomous robotic device 3100 uses information provided by the high-level support in the service response 3105 to generate its own plan to overcome the hindrance to the task. Illustrative examples include the autonomous robotic device 3100 generating a new navigation route based on information in the service response 3105, using information in the service response 3105 for one task to distinguish and choose objects in subsequent tasks, generating a new stacking plan using information about the current state of the stack identified in the service response 3105, to name a few

In the above examples, it should be apparent that the service response 3105 does not provide human control over the autonomous robotic device 3100. Rather, the autonomous robotic device 3100 uses the information in the service response 3105 to perform a task autonomously. In fact, in some cases, the autonomous robotic device 3100 may decline to follow a recommended course of action identified in the service response 3105. For example, the autonomous robotic device 3100 may determine that, even using the information in the service response 3105, the autonomous robotic device 3100 cannot complete a task. In such cases, the autonomous robotic device 3100 may, for example, generate a new service request, abort the autonomous operation or task, or return an error code to the service controller 3150.

As stated above, upon requesting human intervention in relation to completing a task, the autonomous robotic device 3100 uses the service response 3105 to complete the task independent of any control of the autonomous robotic device 3100 by the service controller 3150 or a human interventionist. Further, the autonomous robotic device 3100 does not leave an autonomous operation mode to complete the task. Any autonomous device includes finite state machine logic, artificial intelligence, or some other underlying program logic that configures the device to carry out operations in an autonomous mode. Conventionally, human intervention to complete a task requires discontinuing the autonomous mode of operation in favor of a human operation mode such as teleoperation. In accordance with the present disclosure, the autonomous robotic device 3100 remains in the autonomous operation mode while generating the request, receiving the service response, and performing the operation autonomously based on the service response. The high-level support provided in the service response provides the autonomous robotic device 3100 with sufficient information to resolve the dilemma encountered by the underlying program logic, thus allowing the autonomous robotic device 3100 to transition to the next state. Further, the autonomous robotic device 3100 does not discontinue a perception loop associated with the autonomous mode of operation. That is, when performing the autonomous operation in accordance with the service response 3105, the autonomous robotic device 3100 continues to receive GPS data, camera data, tactile sensor data, and other environmental sensors to aid the autonomous robotic device 3100 in performing the autonomous operation in accordance with the service response 3105.

In view of the foregoing aspects, it will be apparent that completing 3108, by the autonomous robotic device 3100 based on the service response 3105, the task of the autonomous operation by resolving the dilemma independent of human control of the autonomous robotic device is markedly different from human intervention through teleoperation of an autonomous device and from a teleoperation mode. For example, teleoperation requires continuous communication between the remote controller device and the autonomous device (e.g., a constant stream of joystick coordinates). By contrast, the autonomous robotic device 3100 receives assistance intermittently in the form of a discrete service response 3105. A robotic device operating in a teleoperation mode has discontinued its autonomous operation mode and thus does not utilize the finite state machine logic, artificial intelligence, or other underlying program logic to perform the operation. By contrast, the autonomous robotic device 3100 continues the autonomous operation mode and compliments its underlying program logic with human support. For example, an autonomous robotic device may resolve a dilemma independent of human control of the autonomous robotic device by the autonomous robotic device remaining in the autonomous mode of operation in which autonomous underlying program logic of the autonomous robotic device continuously operates. A robotic device operating in a teleoperation mode does not require a perception loop that continually senses the environment. By contrast, the autonomous robotic device 3100 uses the support provided in the service response 3105 in conjunction with its own perception to complete the task autonomously. For example, an autonomous robotic device may resolve a dilemma independent of human control of the autonomous robotic device by the autonomous robotic device utilizing a perception loop that continually senses an environment of the autonomous robotic device.

Exemplary embodiments of the present invention are described largely in the context of a fully functional computer system for enhancing autonomous operation in robotic devices with human intervention. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method of enhancing autonomous operation in robotic devices with human intervention, the method comprising: identifying, by an autonomous robotic device, that a state of an autonomous operation requires human intervention; transmitting, by the autonomous robotic device to a service controller, a service request based on the state; receiving, by the autonomous robotic device, a service response from the service controller, wherein the service response is generated by the service controller based on a set of interventionist responses from a set of human interventionists; and performing, by the autonomous robotic device, the autonomous operation in accordance with the service response.

2. The method of statement 1, wherein the service response provides high level support enabling the autonomous robotic device to autonomously perform the autonomous operation.

3. The method of statement 1 or 2, wherein performing the autonomous operation in accordance with the service response is characterized by noncontinuous communication from the service controller.

4. The method of any of statements 1-3, wherein the autonomous robotic device completes the autonomous operation based on the service response independent of human control of the autonomous robotic device.

5. The method of any of statements 1-4, wherein transmitting the service request, receiving the service response, and performing the autonomous operation are carried out without discontinuing an autonomous operation mode.

6. The method of any of statements 1-5, wherein the autonomous robotic device completes the autonomous operation without teleoperation by a human operator.

7. The method of any of statements 1-6, wherein identifying, by the autonomous robotic device, a condition related to the autonomous operation that requires human intervention includes: determining that a task related to the autonomous operation is beyond a capability of the autonomous robotic device.

8. The method of any of statements 1-7, wherein the capability is based at least on a sufficiency of information to perform the task.

9. The method of any of statements 1-8, wherein the capability is based at least on an operational design domain.

10. The method of any of statements 1-9, wherein the capability is based at least on a historical record related to the task.

11. The method of any of statements 1-10, wherein the capability is based on a capability to select a next task.

12. The method of any of statements 1-11, wherein the capability is based on a capability to determine that a task was successfully completed.

13. The method of any of statements 1-12, wherein identifying, by the autonomous robotic device, a condition related to the autonomous operation that requires human intervention includes: identifying that there is insufficient confidence to successfully perform a task related to the autonomous operation.

14. An autonomous robotic device including a processor and a memory storing processor-executable instructions that, when executed by the processor, configure the autonomous robot device to: identify, by the autonomous robotic device, that a state of an autonomous operation requires human intervention; transmit, by the autonomous robotic device to a service controller, a service request based on the state; receive, by the autonomous robotic device, a service response from the service controller, wherein the service response is generated by the service controller based on a set of interventionist responses from a set of human interventionists; and perform, by the autonomous robotic device, the autonomous operation in accordance with the service response.

15. The autonomous robotic device of statement 14, wherein the autonomous robotic device completes the autonomous operation based on the service response independent of human control of the autonomous robotic device.

16. A method of enhancing autonomous operation in robotic devices with human intervention, the method comprising: encountering, by an autonomous robotic device while performing an autonomous operation, a dilemma that requires human intervention, the dilemma relating to a task of the autonomous operation; transmitting, by the autonomous robotic device to a service controller, a service request related to the dilemma; receiving, by the autonomous robotic device, a service response from the service controller, wherein the service response includes human support for resolving the dilemma; and completing, by the autonomous robotic device based on the service response, the task of the autonomous operation by resolving the dilemma independent of human control of the autonomous robotic device.

17. The method of statement 16, wherein the service response provides high level support enabling the autonomous robotic device to autonomously resolve the dilemma.

18. The method of any of statements 16-17, wherein completing the task based on the service response is characterized by noncontinuous communication with the service controller.

19. The method of any of statements 16-18, wherein completing the task of the autonomous operation by resolving the dilemma independent of human control of the autonomous robotic device is characterized by the autonomous robotic device remaining in an autonomous mode of operation in which autonomous underlying program logic of the autonomous robotic device continuously operates.

20. The method of any of statements 16-19, wherein completing the task of the autonomous operation by resolving the dilemma independent of human control of the autonomous robotic device is characterized by the autonomous robotic device utilizing a perception loop that continually senses an environment of the autonomous robotic device.

It will be understood from the foregoing description that modifications and changes may be made in various embodiments of the present invention without departing from its true spirit. The descriptions in this specification are for purposes of illustration only and are not to be construed in a limiting sense. The scope of the present disclosure is limited only by the language of the following claims.

What is claimed is:

1. A method of enhancing autonomous operation in robotic devices with human intervention, the method comprising:
identifying, by an autonomous robotic device, that a state of an autonomous operation requires human intervention;
transmitting, by the autonomous robotic device to a service controller, a service request based on the state;
receiving, by the autonomous robotic device, a service response from the service controller, wherein the service response is generated by the service controller based on a set of interventionist responses from a set of human interventionists; and
performing, by the autonomous robotic device, the autonomous operation in accordance with the service response.

2. The method of claim 1, wherein the service response provides high level support enabling the autonomous robotic device to autonomously perform the autonomous operation.

3. The method of claim 1, wherein performing the autonomous operation in accordance with the service response is characterized by noncontinuous communication from the service controller.

4. The method of claim 1, wherein the autonomous robotic device completes the autonomous operation based on the service response independent of human control of the autonomous robotic device.

5. The method of claim 1, wherein transmitting the service request, receiving the service response, and performing the autonomous operation are carried out without discontinuing an autonomous operation mode.

6. The method of claim 1, wherein the autonomous robotic device completes the autonomous operation without teleoperation by a human operator.

7. The method of claim 1, wherein identifying, by the autonomous robotic device, a condition related to the autonomous operation that requires human intervention includes:
determining that a task related to the autonomous operation is beyond a capability of the autonomous robotic device.

8. The method of claim 7, wherein the capability is based at least on a sufficiency of information to perform the task.

9. The method of claim 7, wherein the capability is based at least on an operational design domain.

10. The method of claim 7, wherein the capability is based at least on a historical record related to the task.

11. The method of claim 7, wherein the capability is based on a capability to select a next task.

12. The method of claim 7, wherein the capability is based on a capability to determine that a task was successfully completed.

13. The method of claim 1, wherein identifying, by the autonomous robotic device, a condition related to the autonomous operation that requires human intervention includes:
identifying that there is insufficient confidence to successfully perform a task related to the autonomous operation.

14. An autonomous robotic device including a processor and a memory storing processor-executable instructions that, when executed by the processor, configure the autonomous robot device to:
identify, by the autonomous robotic device, that a state of an autonomous operation requires human intervention;
transmit, by the autonomous robotic device to a service controller, a service request based on the state;
receive, by the autonomous robotic device, a service response from the service controller, wherein the service response is generated by the service controller based on a set of interventionist responses from a set of human interventionists; and
perform, by the autonomous robotic device, the autonomous operation in accordance with the service response.

15. The autonomous robotic device of claim 14, wherein the autonomous robotic device completes the autonomous operation based on the service response independent of human control of the autonomous robotic device.

16. A method of enhancing autonomous operation in robotic devices with human intervention, the method comprising:
encountering, by an autonomous robotic device while performing an autonomous operation, a dilemma that requires human intervention, the dilemma relating to a task of the autonomous operation;
transmitting, by the autonomous robotic device to a service controller, a service request related to the dilemma;
receiving, by the autonomous robotic device, a service response from the service controller, wherein the service response includes human support for resolving the dilemma; and
completing, by the autonomous robotic device based on the service response, the task of the autonomous operation by resolving the dilemma independent of human control of the autonomous robotic device.

17. The method of claim 16, wherein the service response provides high level support enabling the autonomous robotic device to autonomously resolve the dilemma.

18. The method of claim 16, wherein completing the task based on the service response is characterized by noncontinuous communication with the service controller.

19. The method of claim 16, wherein completing the task of the autonomous operation by resolving the dilemma independent of human control of the autonomous robotic device is characterized by the autonomous robotic device remaining in an autonomous mode of operation in which autonomous underlying program logic of the autonomous robotic device continuously operates.

20. The method of claim 16, wherein completing the task of the autonomous operation by resolving the dilemma independent of human control of the autonomous robotic device is characterized by the autonomous robotic device utilizing a perception loop that continually senses an environment of the autonomous robotic device.
